(19) United States
(12) Patent Application Publication
(10) Pub. No.: US 2006/0031101 A1
(43) Pub. Date: Feb. 9, 2006

(54) Bi-directional messaging in health care

(76) Inventor: S. Michael Ross, Merion Station, PA (US)

Correspondence Address: DUANE MORRIS, LLP;IP DEPARTMENT, 30 SOUTH 17TH STREET, PHILADELPHIA, PA, 19103-4196, US

(21) Appl. No.: 10/879,357

(22) Filed: Jun. 30, 2004

(51) Int. Cl. G06Q 50/00

(52) U.S. Cl. 705/3

(57) ABSTRACT

A method for patient bi-directional messaging to improve patient adherence to case management, is disclosed. The method extends the provider/patient communication beyond the provider premises. The method includes comparing source characteristics to target characteristics of both source and target patients, respectively thus updating questions posed to the target patients to promote a learning protocol. A PAR3 communication device communicates patient information from the provider to the patient and vice-versa. The bi-directional messaging system improves patient medication adherence, follow-up visits, hospitalization information, quality of life indicators, and a comprehension of educational content related to a particular medical condition.

### FIELD OF THE INVENTION

The present invention is generally related to a medical information management system and, more particularly, is related to a system and method for using bi-directional messaging to improve patient adherence to care management by extending provider/patient communication beyond provider premises.

### BACKGROUND OF THE INVENTION

Medication adherence tends to be problematic among patients. For example, Bipolar Disorder (BPD) is a persistent, severe, long-term illness with associated mortality and morbidity. The treatment of BPD requires prevention of recurrent mood episodes and control of symptoms. One study found that between one half and two thirds of patients may be non-adherent to medications within the first 12 months of treatment. Education and reminders may help improve those adherence outcomes.

There are a number of electronic devices that assist with the administration of prescribed medication and monitor the medical treatment progress. Medication and medical monitoring devices such as those disclosed in U.S. Pat. Nos. 5,200,891 and 5,642,731 provide a number of functions for facilitating patient adherence to prescribed therapies, and for facilitating cross-correlation of compliance data and clinical information about the patient. Those devices rely on program schedules for providing audible and/or visual alert signals at the scheduled times for taking certain medications and indicate the specific compartment from which a particular medication is to be taken, and quantity to be taken. However, that prior art does not have a system for the mass customizing of patient protocols and regimens that is simple to use.

Existing reminder programs provide a unique opportunity to reach patients treated with a specific medication however, there exist a number of limitations. Although refill reminder programs provide additional education on the disease state, it usually is secondary to refill reminders. Studies have demonstrated that in order to improve compliance, patient beliefs regarding their condition and the role of the medications have to change first. Therefore, it is just as important to educate patients about their condition as it is to remind them to refill their medications. Intervention is started shortly before refill is due and stopped if medication is not refilled within thirty days. That intervention method does not utilize the opportunity to educate the patient throughout the period of medication intake and after refills are missed. It might be argued that even if a reminder letter issued five days prior to calculated completion of the medication fill is effective in convincing a patient to take his/her medication regularly, it is not going to result in a timely refill. Further, patient communication is unidirectional. There is an inability to gather patient feedback that introduces a major flaw to the intervention process. In the existing reminder programs, cessation and refill activity is considered as failure, however, without patient input the behavior can be misinterpreted.

Another important aspect of the invention is that it provides a feedback loop to the physician to optimize medication management. For example, based upon daily mood information aggregated from daily contact with patients, the treating physician is better able to titrate an optimal medication regimen. Likewise, if the patient does not seem to benefit from a treatment medication regimen and the provider learns that a patient is not adhering to the prescribed regimen, he/she may avoid changing the medication/dose inappropriately. Rather, the provider focuses his attention on better understanding the reason for the patient's non-adherence (side effects, beliefs about disease state, etc.) and dealing directly with that problem.

Thus a heretofore, unaddressed need exists in the industry to address the aforementioned deficiencies and inadequacies.

### SUMMARY OF THE INVENTION

Embodiments of the present invention provide a system and method for providing bi-directional messaging initiatives to extend provider/patient communication beyond provider premises.

Briefly described, in architecture, one embodiment of this system, among others, is implemented as follows. A method is disclosed that leverages the technology to complement care management extending the reach of providers to support care beyond provider office settings. An automated exchange is used to educate, remind, collect and aggregate patient self-reports to enhance and optimize patient treatment and medication management. Communication is established with patients with a goal of setting up actionable items in response. Evidence based medicine data is transmitted to the patient to improve the quality of the provider-patient interface. The method is customized/personalized and loaded with individual patient specific and condition specific data elements that drive the bi-directional messaging system.

Feedback data from the patient updates the overall patient specific database and is communicated via a communication medium such as a personal data assistant (PDA), a land-line telephone, pagers, personal computers, Internet terminals, cellular telephones, and digital/cable television. In a preferred embodiment, a PAR3 messaging system, from PAR3 Communications, is used as the bi-directional messaging communications system.

The PAR3 platform is a combination of telephony, Internet, and database technologies that delivers interactive alerts to customers in an automated, timely manner. The bi-directional messaging system ‘learns’ from the patient's responses and, via a patient specific algorithm, is highly specific to gaps in the patient's knowledge or deficit in his compliance with a care plan. The PAR3 system allows the patient to respond to questions through the telephone keypad and store the responses in a database. Information is delivered in “chunks” and the content of the information is assessed through the bi-directional discourse during the course of any particular contact and subsequent contacts. Information that is mastered is extinguished or repeated less frequently, and vice versa for information that is not been mastered, until mastery is achieved. Of significance is that communication to the patient is preference driven. Not only does the patient specify what days/times he wants to receive contacts, he also selects a primary, secondary and tertiary contact preference (first try cell phone; then try land-line telephone and finally leave a message via e-mail) or any permutation thereof.

Although in the preferred embodiment, the PAR3 system is utilized, it is only one of the many commercially available platforms that may be employed as the interface platform to deliver bi-directional communications to the patient. Any communication platform that intrinsically includes updating to retrieved information, and learning from the retrieved information and re-structuring questions accordingly can be used.

FIG. 1 illustrates a proposed layout of a bi-directional messaging system using a PAR3 system setup. The main interaction between this system and the patients is the 2-way messaging function provided by PAR3. This is an automated telephone bi-directional message system that provides information and asks questions of the patients. This system allows the patient to respond to the questions through the telephone keypad and stores the responses in a database. The software interacts with the PAR3 messaging system in two ways, uploading a comma-limited, uncompressed ASCII data file to control the messages (the Message Control file) and downloading a similarly-formatted file containing the results of a previous patient interaction (the Message Results file). Transfer of the data files occurs using SFTP with 128-bit encryption (or a comparably secure method). The PAR3 system acts as the SFTP server for this transaction.

Message Control

This software controls the delivery of information and questions from the automated telephone system via uploading a control file to a specific location. One control file is provided each day as an automated process. A unique identifier identifies each user. Unique item numbers identify blocks of information and questions. Logic is incorporated into the control file to identify branches based on responses to specific question.

Message Results

This software retrieves the results of the previous day's surveys via downloading a results file from a specific location. One results file is collected each day as an automated process. A clearly defined format identifies each user, identifies the question and provides the response.

Claims Database Integration

This software will query against the patient claims database(s) to gather information to incorporate into the patient data reports. Because of the potential complexity of the claims database(s), a project-specific “view” or set of summary tables will likely be added to the database to simplify query processing.
Hardware Requirements

Hardware is needed to support the operation of this software. The following hardware is required:

Server hardware for a Web server and a database server.
Internet connection—This includes the physical wiring as well as any firewall protection.
Power protection (recommended).
Dedicated printer
Dedicated fax machine or fax/modem.
Off-the-Shelf Software Requirements

A software environment is needed to support the operation of this software. The following software is required:
Web server—IIS Windows2000 based Web server.
ASP client-server development environment.
Database—SQL Server 2000
HTTPS SSL security

PAR3 needs secure FTP (SSL) for its host server

Events that drive the bidirectional messaging are:
1) back end of an electronic medical record (ambulatory or hospital) or Continuity of Care Record;
2) back end of a disease or drug registry;
3) managed care organization pharmacy or medical claims systems;
4) state Medicaid or Medicare pharmacy or medical claims database;
5) disease/care management system;
6) pharmacy benefit management system;
7) retail pharmacy system;
8) pharmaceutical or clinical research organization systems for patients participating in clinical trials or for post market surveillance;
9) laboratory systems; and
10) home remote diagnostic/monitoring systems.

In one embodiment, the bi-directional messaging system communicates with asthma patients.

In another embodiment, the bi-directional messaging system communicates with diabetes patients.

In another embodiment, the bi-directional messaging system communicates with patients suffering from depression.

In another embodiment, the bi-directional messaging system communicates with bipolar patients.

Other embodiments of the bi-directional messaging system are possible to encompass various disease conditions such as: hypertension; coronary artery disease; congestive heart failure, and chronic obstructive pulmonary disease. Heretofore, the list of embodiments is limited only by the number of disease conditions.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like-reference numerals designate corresponding parts throughout the several views:

FIG. 1 is a flow diagram illustrating a general layout of a preferred embodiment of the invention with a PAR3 intelligent response platform;

FIG. 2 is flow diagram of an embodiment of the invention for asthma patients;

FIG. 3 is a flow diagram of an embodiment of the invention for bipolar patients;

FIG. 3A is a flow diagram of the suicide screen module in FIG. 3;

FIG. 3B is a flow diagram of the education module in FIG. 3;

FIG. 3C is a flow diagram of the medication adherence module in FIG. 3;

FIG. 3D is a flow diagram of the mood rating module in FIG. 3;

FIG. 3E is a flow diagram of the severity rating module in FIG. 3;

FIG. 3F is a flow diagram of the sleep rating module in FIG. 3;

FIG. 4 is a flow diagram of an embodiment of the invention for diabetes patients; and

FIG. 5 is a flow diagram of an embodiment of the invention for patients experiencing depression.

### DETAILED DESCRIPTION OF THE INVENTION

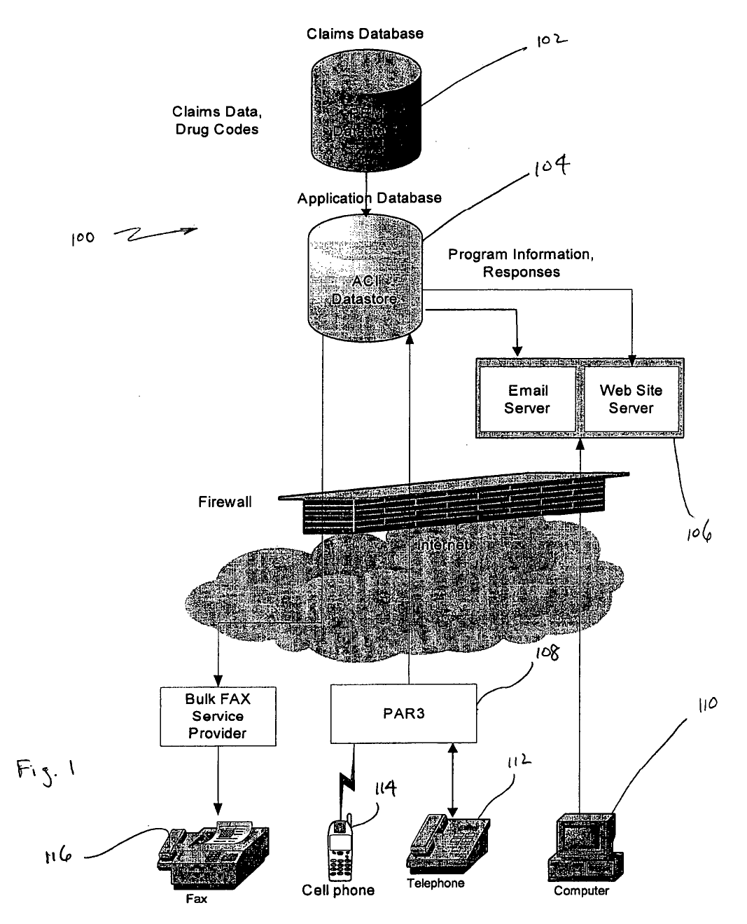

FIG. 1 illustrates a preferred method 100 for extending provider-patient communication beyond the office setting using a PAR3 intelligent response platform 108 for bi-directional messaging. A patient data storage database 102 that feeds into a target patient data source 104 is accessible via a website server 106, the PAR3 intelligent response platform 108 and another device such as a fax server 116. Information may be shared between a service provider and the patient via the different modes of communication. The patient data storage database 102 includes all of the patients that might be considered for a particular inquiry, and may be supplied by a provider, managed care organization, State Medicaid/Medicare databases, disease management company, clinical research organization, and hospital records. Depending upon a particular medical application, a second target patient data source 104 is created from the patient data storage database 102 from which actual messaging will be prompted. The target patient data source 104 may be accessed by a fax server 116, a computer 110 via a website server 106 which may include e-mail capability, and the PAR3 intelligent response platform 108. The PAR3 intelligent response platform 108 includes a cell phone 114, a land-line telephone 112, and other communication devices of similar character. The patient data storage database 102 may also include claims of numerous patients that have had some contact with a particular hospital environment.

Asthma Patient

An embodiment of the invention for pediatric asthma patients is herein described. This embodiment involves investigations of children with asthma-examined factors related to medication adherence, however, the embodiment can encompass adults wherein bi-directional communication is directly to the patient without an intervening caregiver.

Asthma is the most common chronic childhood disease, with over a two-thirds increase in prevalence in the last twenty years. Asthma differentially affects racial and ethnic minorities living in inner cities. Assessments of children in inner-city settings estimate the prevalence of asthma to be two to three times the average US rate. Risk factors that may contribute to this disparity include race/ethnicity, socioeconomic status (SES), environment (indoor and outdoor), psychosocial factors, and inner-city health care delivery.

Direct and indirect costs of asthma are high. With approximately 3 million individuals up to age 18 affected with asthma, 200,000 require hospitalization each year. In the early 1990's between $2 to $3.4 billion were attributed to the total cost of asthma in children under age 18. Medication non-adherence contributes to morbidity and mortality as well as to increased costs of treatment.

Results indicate that many caregivers are concerned with side effects of medications (81.1% of caretakers who were adherent and 89.5% of caretakers who were non-adherent). Many respondents also indicate having doubts regarding the usefulness of medications (34.4% of those considered adherent and 54.2% who admitted non-adherence). The use of preventive medicines occurs in 23.5%. The embodiment suggests that underserved families may be at risk for non-adherence as a result of inaccurate perceptions about asthma and appropriate treatments.

This embodiment is intended for communicating with caregivers of children with asthma. The intervention will consist of bi-directional messaging via cell phones. Messages provide educational information about asthma, assess condition status, and provide behavioral reminders related to treatment plan adherence.

This embodiment optimizes treatment plan adherence in children with asthma by facilitating and reinforcing education and behavioral modification. Extending provider reach beyond emergency room encounters results in a paradigm shift in the treatment of pediatric asthma in an urban setting.

The embodiment provides value to both the patient and the provider by acting as an extension of the physician-patient dialogue. Information is provided to the caregivers to help them manage their patient's asthma, and allow them to communicate back about their patient's condition. The active intervention consists of customized (patient-specific) bi-directional messaging via a cellular phone. Patient messages provide asthma self-management education, reinforcement, and reminders, as well as assess treatment plan adherence.

The embodiment includes a prospective, randomized, between-groups analysis. Patients are randomly assigned to Messaged Group and Non-Messaged Group. The Non-Messaged Group is further divided into the Automated Group and the Manual Group.

Patients:

The following are preliminary enrollment criteria developed for patient enrollment:
Caregivers of children presenting with acute asthma exacerbation
Children of the following age range—1 to 11 years
Treatment with a controller medication or discharge with a prescription for an asthma controller (including inhaled corticosteriods, combination inhaled steroids, inhaled beta agonists, leukotriene inhibitors, and mast cell stabilizers)
English or Spanish as the primary language
   Patient Enrollment:

During enrollment, proper information is collected, including: study enrollment form, consent form, discharge sheet, and hospital chart cover sheet. Following patient enrollment, patients are assigned to one of three groups:
Messaged Group—active intervention group
Automated Control Group—control group
Manual Control Group—control group

Upon discharge from a hospital, patients/caregivers are provided with a packet of documentation including copies of enrollment forms and materials, as well as educational materials related to the proposed treatment plan. A free cellular phone is distributed to the patient.

Protocol Execution:

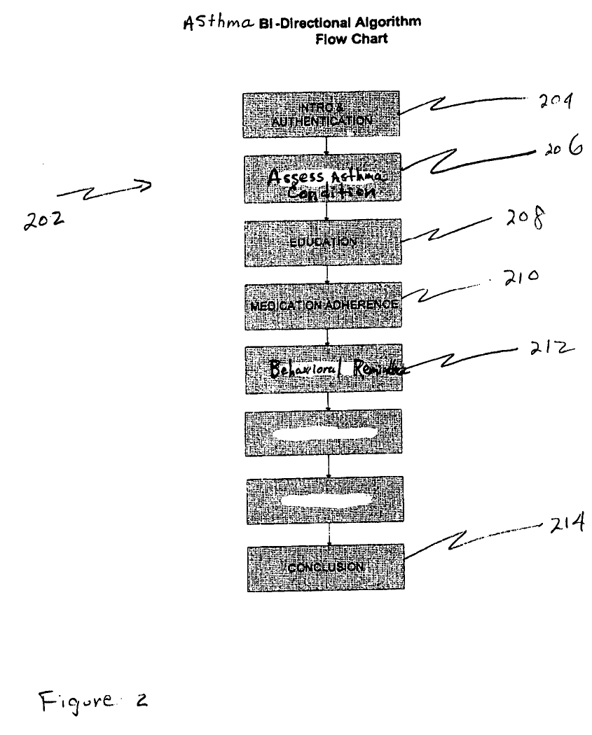

Messaged Group patient intervention:
   Following an initial registration survey, the Messaged Group receives three telephonic messages per week, to which they are asked to reply via the cell phone keypad.
      Messaging provides education, reinforcements, and reminders with focus on medication adherence, trigger control, self-monitoring, follow-up visits, etc.
      Messaging content is available in two languages: English and Spanish.
      Messaging content is customized to patient's name, gender, age, asthma drugs (based on information captured during enrollment), and any self-reported information.
      During bi-directional messaging, condition-specific information is collected directly from patients/caregivers.
      Questioning the patients using the asthma bi-directional algorithm 202 (FIG. 2).
      During bidirectional messaging, patients are provided access to available community resources.
   Monthly qualitative surveys are delivered to and completed by patients/caregivers through bi-directional messaging to assess condition status, treatment plan adherence, and quality of life.
Non-Messaged Automated Group:
   Monthly qualitative surveys are delivered to and completed by patients/caregivers through bi-directional messaging to assess condition status, treatment plan adherence, and quality of life.
Non-Messaged Manual Group:
   Monthly qualitative surveys are conducted with patients/caregivers by the Advanced Concepts interviewers to assess condition status, treatment plan adherence, and quality of life.
      Ongoing Analytics and Reporting:

Ongoing analytic analyses will be conducted. Summary information is provided to medical personnel in the format of ongoing periodic reports. Outcomes are assessed using:
Service (bi-directional messaging) utilization data
Self-reported data collected from patients
Spirometry assessments (when available for children ≧6 years old)

FIG. 2 is a flow diagram of the bi-directional messaging algorithm 202 that is used for questioning the asthma patients. The bi-directional messaging algorithm 202 controls the sequence of questioning to the asthma patients and, based on the patient's responses, updates the questions asked to promote a more learned protocol.

In the introduction/authentication module 204, the asthma patient is asked criteria such as his name, address, phone number, gender etc. After the introduction/authentication module 204 authenticates the identity of the asthma patient, the assess asthma condition module 206 reviews the asthmatic condition of this target asthma patient. The review includes assimilating any feedback data that may have been received from the asthma patient from a previous contact or event. Based on the results from the review of the asthma patient's condition via the assess asthma condition module 206, the asthma patient receives educational information through a series of questions regarding his specific/customized medical condition from the education module 208.

The education module 208 familiarizes the asthma patient with the specifics of his medical condition and how the prescribed medications affect the current medical condition. Such topics as sneezing, coughing, heavy breathing and shortness of breath are discussed in education module 208.

Once acquainted with his medical condition, the asthma patient receives reinforcement via the medication adherence module 210. The asthma patient is queried on topics that reinforce the continued adherence to the medication regimentation as prescribed, and to take care of his asthma.

As a reminder, the behavioral reminder module 212, through a series of questions, reminds the asthma patient to refill his medications promptly and to keep an asthma diary. Further instructions are also given regarding questions to present to his medical provider at the next scheduled visit, the date of which is also reinforced.

In conclusion, the conclusion module 214 summarizes the encounter with the asthma patient and reinforces that the asthma patient follow his provider's medical advice. The patient is also reminded that the observations from the asthma diary are to be brought to the follow-up office visit.

An example of a bi-directional contact using the above-described asthma managing algorithm 202 with an asthma patient is described below.

### EXAMPLE OF BI-DIRECTIONAL CALL EXERPT/PROTOCOL

Previous Reinforcement:

True or False: Due to the swelling, the airways in people with asthma are narrower than in healthy people
OPTION #1: IF FALSE—Actually, this statement is true. Asthma makes the sides of the airways in your child's lungs inflamed or swollen all the time. This swelling makes the airways narrower than healthy airways
OPTION #2: IF TRUE—Exactly! This statement is true. Asthma makes the sides of the airways in your child's lungs inflamed or swollen all the time. This swelling makes the airways narrower than healthy airways.
   Education:

When [CHILD'S NAME] airways narrow or become smaller, any of the following signs and symptoms can appear: coughing; wheezing—which is a whistling sound made during breathing; feeling short of breath or easy winded; feeling tightness in the chest as if someone is squeezing or sitting on your chest; feeling tired; trouble breathing out; heavy breathing; waking up often in the middle of the night.

It is important to know that [CHILD'S NAME] asthma doesn't go away when [HIS/HER] symptoms go away. Remember that your child's airways can be swollen even when no signs or symptoms are present. That's why it's important to keep taking care of [HIS/HER] asthma.

Reinforcement:

True or False: If [CHILD'S NAME] has no signs or symptoms of asthma, [HIS/HER] airways are not swollen
OPTION #1: IF FALSE—You are right! This statement is false. [CHILD'S NAME] asthma doesn't go away when [HIS/HER] symptoms go away. Remember that [CHILD'S NAME] airways can be swollen even when no signs or symptoms are present. That's why it's important to keep taking care of [HIS/HER] asthma.
OPTION #2: IF TRUE—Not exactly. This statement is false. [CHILD'S NAME] asthma doesn't go away when [HIS/HER] symptoms go away. Remember that [CHILD'S NAME] airways can be swollen even when no signs or symptoms are present. That's why it's important to keep taking care of [HIS/HER] asthma.
   Reminders:

According to our last call, you indicated that [CHILD'S NAME] takes [RELIEVER] to relieve asthma symptoms or to manage attacks. Did you know that if [CHILD'S NAME] uses [RELIEVER] more than 2 times a week OR if you refill it at the pharmacy more than 2 times a year, [CHILD'S NAME] asthma may not be well controlled and adjustment in treatment may be required? Next time, monitor how frequently [HE/SHE] uses [RELIEVER].

Remember to keep an asthma diary and bring it to your next appointment. This is a good way to tell if [CHILD'S NAME] asthma is getting better or worse

IF HAS ACTION PLAN—Be prepared for your appointment with [CHILD'S NAME] primary care doctor. Here is what you can do:

First, write down your home observations of [CHILD'S NAME] asthma

Second, bring to the visit your written observations along with [CHILD'S NAME] medicines, and written action plan

During the visit, ask questions to make sure you understand your doctor's instructions. Tell your doctor if you or your child may have hard time following his or her directions. Be honest your doctor is there to help

Lastly, don't forget to write down your doctor's instructions before leaving the office

IF HAS NO ACTION PLAN—Be prepared for your appointment with [CHILD'S NAME] primary care doctor. Here is what you can do:

First, write down your home observations of [CHILD'S NAME] asthma

Second, bring to the visit your written observations along with [CHILD'S NAME] medicines. Also, since you indicated in our last survey that you don't have an action plan for [CHILD'S NAME], don't forget to ask your doctor about getting one

During the visit, ask questions to make sure you understand your doctor's instructions. Tell your doctor if you or your child may have hard time following his or her directions. Be honest your doctor is there to help

Lastly, don't forget to write down your doctor's instructions before leaving the office.

Bipolar Patient

An embodiment of the invention for bipolar patients is herein described.

Bipolar disorder (BPD) is a persistent, severe, long-term illness with associated mortality and morbidity. The treatment of BPD requires the prevention of recurrent mood episodes and the control of symptoms. Medication adherence tends to be problematic among patients with bipolar disorder. One study found that between one half and two thirds of patients become non-adherent to medications within the first 12 months of treatment. Education and reminders are designed to help improve those adherence outcomes.

Methods for psychiatrists to collect long-term monitoring information from patients regarding medication use, mood status, social functioning, sleep duration, and other relevant status indicators are available. Those types of charts are relatively easy for patients to complete, but the workload on the clinician is very heavy. In order for information to be useful to clinicians, it must be represented graphically over time, which is a costly and time-consuming process. One study estimated the data costs for one patient using the Life Chart Method (LCM) at $5,000 per year. Automating this process could assist clinicians in monitoring their patients' status and making any necessary adjustments in treatment regimens without delay.

In this embodiment, what is disclosed is a treatment plan for adherence and monitoring in patients with BPD by facilitating communication between a patient and his psychiatrist. Collecting and disseminating the patient information to providers results in a paradigm shift in the treatment of BPD.

The embodiment provides value to both the patient and the psychiatrist by acting as an extension of the physician-patient dialogue. Information is provided to the patient to help him manage his bipolar disorder, and allow him to communicate back about his condition. The active intervention consists of customized (patient-specific) bi-directional messaging via the modality of choice for each patient (i.e., landline, cellular/SMS, email/web, wireless devices, etc.). Patient messages assess the condition status by collecting mood chart information and provide basic education related to treatment plan adherence.

To assist psychiatrists in managing their patients, patient self reports are sent back to psychiatrists to facilitate long-term monitoring.

Patients are randomly assigned to Messaged Group and Non-Messaged Group.
Patient enrollment criteria:
   age ≧18 years
   Diagnosis of Bipolar Disorder
   Give consent to receive their respective pharmacy claims data
   Treated with pharmacotherapy for BPD
      Program Execution:

The program execution embraces the following components:
Patient enrollment and randomization
Protocol execution
Ongoing analytics and reporting
   Patient Enrollment:

Each psychiatrist enrolls eligible patients during the period immediately following psychiatrist recruitment. In subsequent phases, patients are offered the opportunity to enroll a family member or a friend as an option. During enrollment at the psychiatrist office, information is collected from patients, including: consent to participate, insurance information, and authorization to access patient claims data, demographics, contacts, and baseline mood chart information (diagnoses, comorbidities, medication dosages, and daily regimens). Patients are provided with a packet of documentation including copies of enrollment forms and materials explaining the treatment program. Following patient enrollment, psychiatrists submit enrollment information, and the patients are randomly assigned to one of two groups:
Messaged Group—active intervention group
Non-Messaged Group—control intervention group
   Protocol Execution:
Messaged Group patient intervention:
   Patients receive bi-directional messages, via their preferred modality (phone, cell phone, or email) 7 times a week
      Mood charts are adapted for use in the messaging modality selected by the patient
   Mood chart information is collected automatically during the course of bi-directional messaging
   Periodic qualitative surveys are delivered to and completed by patients through bi-directional messaging (every 1-3 months)
   Patients are able to requests copies of their mood chart reports by mail, fax, or web according to preference
Non-Messaged Group patient intervention:
   Patients receive mood charts, accompanying manual, and educational content via mail periodically (every 1-3 months)
   Patients are asked to complete mood charts and bring them to the psychiatrist for subsequent visits
   Periodic qualitative surveys are mailed to the patients along with the mood charts by mail. Patients are asked to complete paper surveys and return them by mail.
Psychiatrist intervention
   Psychiatrists receive the following periodic reports sent according to the method of preference selected:
      Bi-weekly Activity Reports—provide patient activity status as it relates to group assignment, medication regimen on file, and two-week activity with bi-directional messaging for Messaged Group or activity with submitting mood charts and surveys for Non-Messaged Group. These reports will serve as the mechanism to alert or remind psychiatrists about patients' inactivity and as a prompt for updating patient information
      Monthly Chart Reports—will provide patient mood chart data for each patient enrolled in Messaged Group only
      Priority Update Reports—will be generated based on mood chart information or patient reports of medication change from Messaged Group only.
   Psychiatrists are able to, on demand (via secure website, mail or fax), view their patient's mood chart reports, medication adherence feedback, sleep patterns, etc. at any time during the patient evaluation.
   Periodically psychiatrists and patients are asked to complete surveys related to their bi-directional intervention.
      Ongoing_{L}Analytics and Reporting:

Throughout the execution period, ongoing analytic analyses are conducted. Summary information is provided in the format of ongoing periodic reports. Outcomes are assessed using pharmacy claims data and self-reported data collected from the patients. Qualitative information collected through surveys is assessed.

Final Analytics and Reporting:

Quantitative Assessment:
   Compare treatment plan adherence in Messaged and Non-messaged Groups utilizing self-reports and pharmacy claims (when available)
Qualitative assessment:
   Psychiatrists—expectations, perceived value, and experiences
   Patients—expectations, perceived value, and experiences

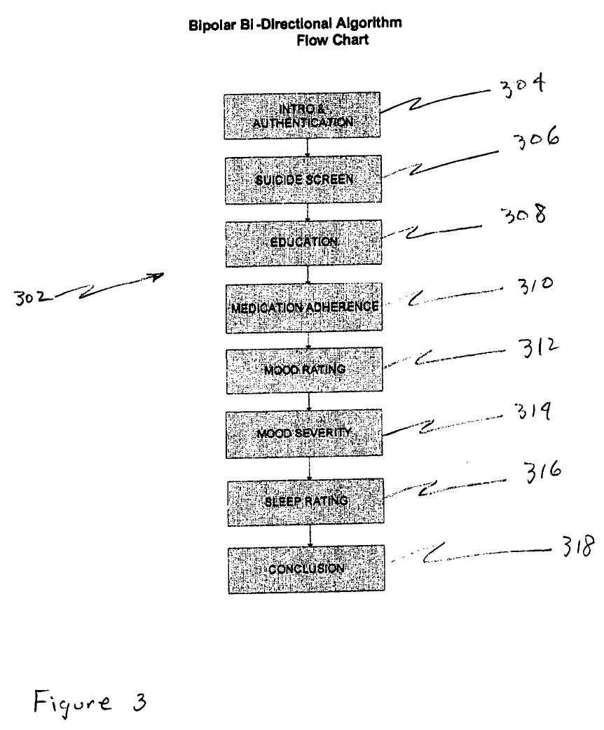

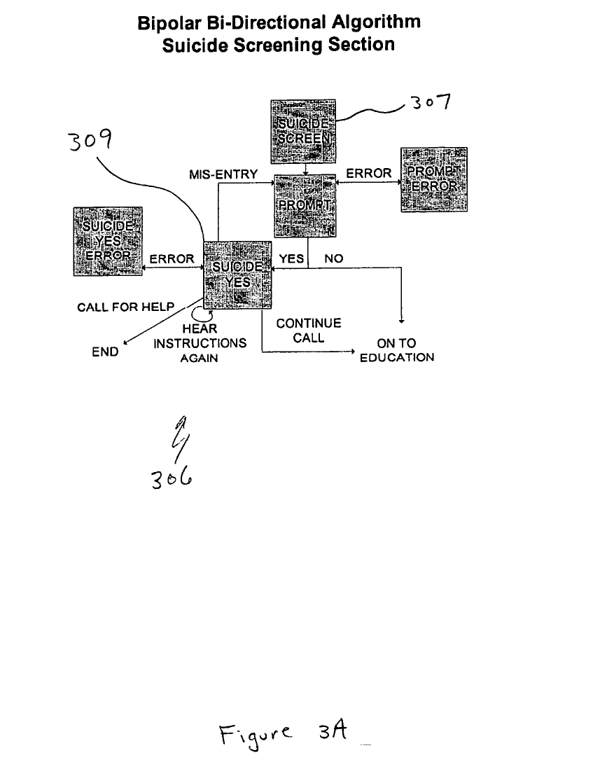

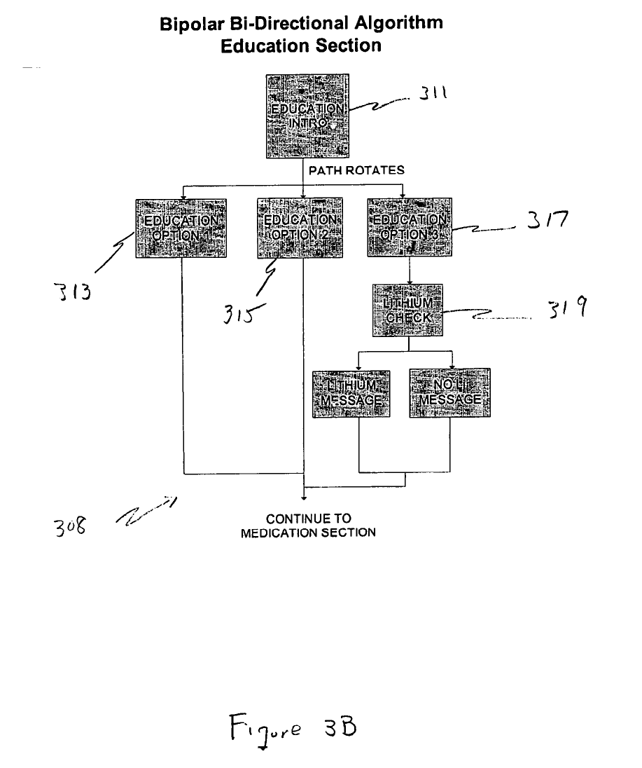

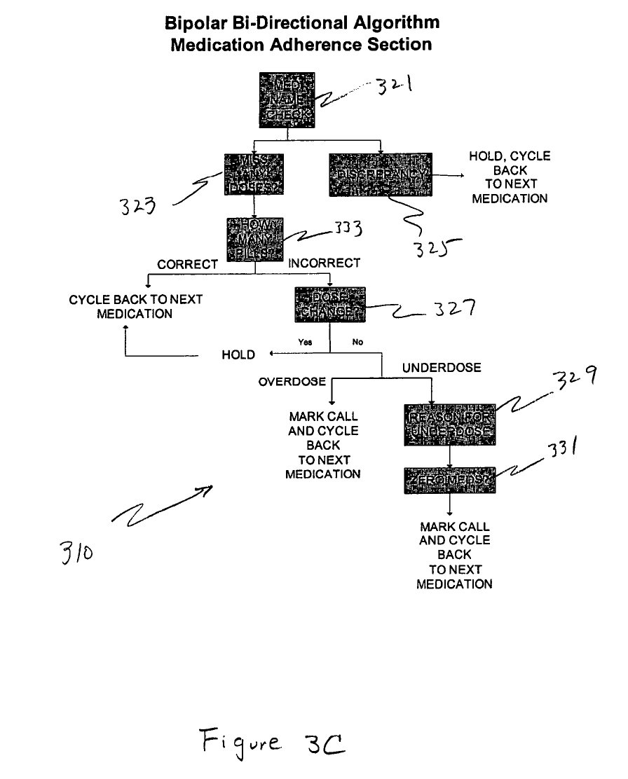

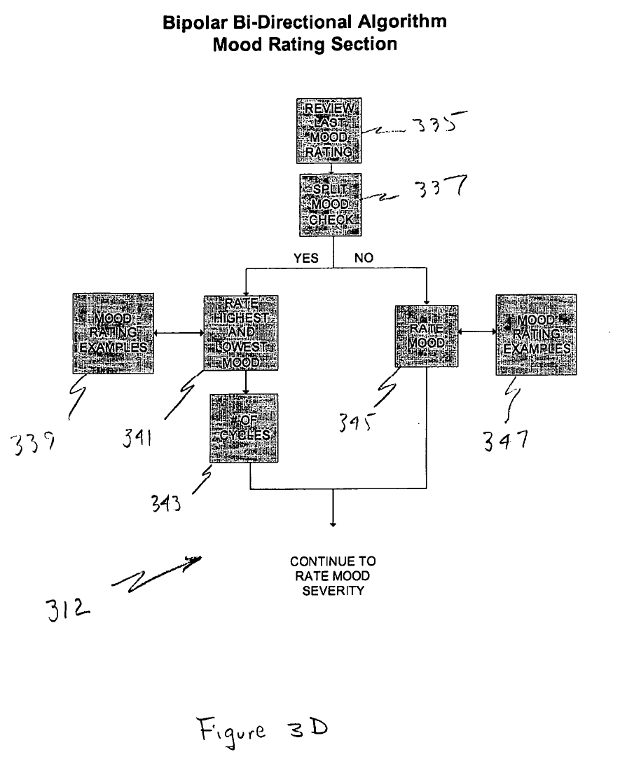

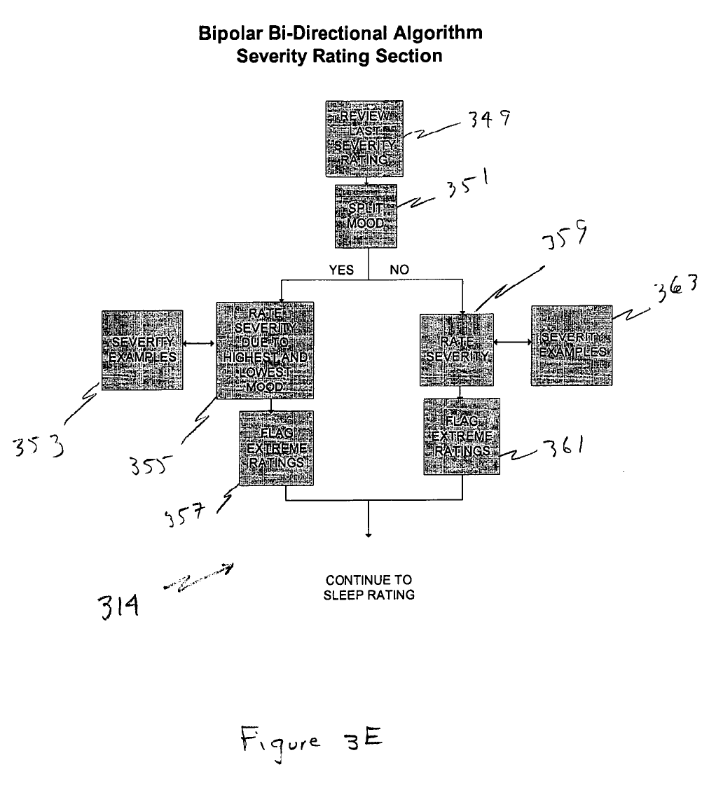

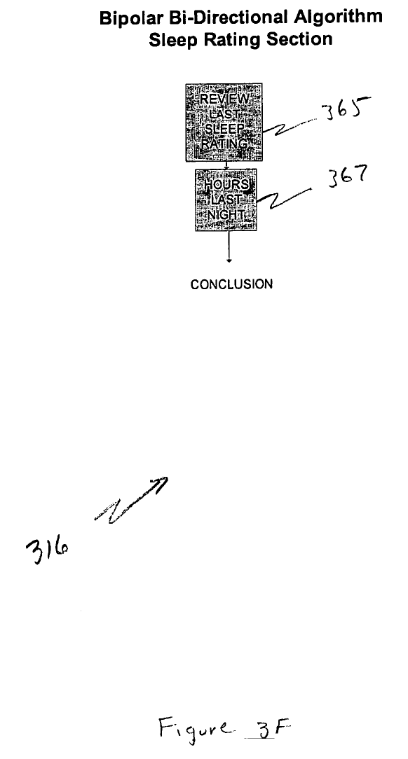

FIG. 3 is a flow diagram of one embodiment of the bi-directional messaging algorithm 302 that might be used for questioning the bipolar patients. The bi-directional messaging algorithm 302 controls the sequence of questioning to the bipolar patients and, based on the patient's responses, updates the questions asked to promote a more learned protocol. Table X lists a sample source code that may be used for the flow diagram depicted in FIG. 3.

In the introduction/authentication module 304, the bipolar patient's identity and demographic information is assimilated. After the introduction/authentication module 304 authenticates the identity of the bipolar patient, the suicide screen module 306 queries the bipolar patient on suicide topics. FIG. 3A illustrates a flow diagram of the suicide screen module 306. Table I lists sample questions that are asked in the suicide screen module 306. In the suicide screen module 306, the suicide screen sub-module 307 queries the patient on the degree of his ‘feelings’. Based on a positive response, the suicide-yes sub-module 309 directs the patient to contact professional help.

FIG. 3B illustrates the education module 308 and highlights three optional questions that may be posed to the bipolar patient. Table II lists those three sample questions that are asked in the education module 308 along with the rationale for asking. In the education module 308, the education introduction sub-module 311 presents the three optional questions referenced above. The education option 1 sub-module 313, the education option 2 sub-module 315, and the education option 3 sub-module 317 pose questions to the patient to test the educational level of the patient's awareness of his medical condition. Based on his response to the education option 3 sub-module 317, the patient is questioned on the medication regimen related to Lithium in the Lithium check sub-module 319.

FIG. 3C illustrates the medication adherence module 310 and shows sample queries regarding medications and dosages. Table III further discloses the sample questions posed in the medication adherence module 310. Table III also lists areas of concern that arise with the current questions posed in the medication adherence module 310. In the medication adherence module 310, the patient's name is verified in the medical name check sub-module 321. The patient is then asked whether he has missed any medication doses in sub-module 323, and whether there are any discrepancies in the number of pills taken, via sub-module 325. Based on the patient's response to sub-module 323, the number of pills missed is ascertained in sub-module 333 and, via sub-module 327, the patient is further queried as to whether there is a medication dose change. Based on the patient's response to sub-module 327, an overdose or under-dose is determined with the latter forwarded to sub-module 329 to determine the reason for the under-dose. Sub-module 329 asks the patient whether the under-dose is due to problems in medications such as zero medications remaining and stores the response in sub-module 331.

FIG. 3D illustrates the mood rating module 312 which requests the bipolar patient to rate his general mood on a graduated scale of 0-100. Table IV lists the questions that are asked in the mood rating module 312 with regard to the mood rating. In the mood rating module 312, the patient is told his last mood rating via sub-module 335. The current mood questioning is initiated by sub-module 337 and is forwarded to two different paths depending on the response. If the response to sub-module 337 is ‘yes’, the patient is forwarded to sub-module 339 that gives samples of mood ratings and requests the patient to rate his mood via sub-module 341. Sub-module 341 continues the questioning by requesting the patient to delineate the number of cycles of his mood and storing the response in sub-module 343. If the response to sub-module 337 is ‘no’, sub-module 345 requests the patient to rate his mood, but only in a general way. Mood examples are also given to assist the patient in the rating via sub-module 347.

FIG. 3E further illustrates the mood ratings illustrated in FIG. 3D and highlights the questions posed to the bipolar patient to rank the severity of his mood via the mood severity module 314. Table V, lists the questions that are presented in the mood severity module 314. In the mood severity module 314, the patient's last severity rating is reviewed via sub-module 349. The patient's current questioning as to his mood severity rating is split into two paths. If the ‘yes’ path of questioning is taken, the patient is requested to rate the severity of the highest to the lowest mood via sub-module 355. Severity mood examples are given in sub-module 353. The extreme ratings obtained from sub-module 355 are highlighted for further investigation in sub-module 357. If the response to mood severity in sub-module 351 is ‘no’, then the rate severity sub-module 359 requires less extensive ratings of the mood severity. Sample severity ratings are presented in sub-module 363 to assist in the ratings. The extreme ratings are flagged in sub-module 361.

FIG. 3F illustrates the sleep rating module 316 that queries the bipolar patient on the number of hours of sleep he receives. Table VI lists the sample questions posed to the bipolar patient via the sleep module 316. In the sleep module 316, the patient's prior sleep results are reviewed by sub-module 365. In sub-module 367, the patient is then asked for the number of hours of sleep he received last night.

The conclusion module 318 thanks the bipolar patient for his participation and assistance in managing the short and long-term treatment of his medical condition.

An example of the bi-directional contact related to mood charting is as follows. The questions presented relate to FIGS. 3D-3F and the sequence that is followed for investigating the patient's mood and severity of the mood.

### EXAMPLE OF BI-DIRECTIONAL CALL EXERPT/PROTOCOL RELATED TO MOOD CHARTING

Medications:

Your LAMICTAL regimen is set at [one 200-mg tablet] per day. How many tablets of LAMICTAL did you take yesterday?

Your LITHIUM regimen is set at [three 300-mg tablets] per day. How many tablets of [LITHIUM] did you take yesterday?

Your [SYNTHROID] regimen is set at [one 0.1 mg tablet] per day. How many tablets of [SYNTHROID] did you take yesterday?

Sleep:

Please estimate how many hours of sleep you had last night

Mood Changes:

Throughout the course of the previous day, did you experience any episodes of sudden, distinct, and significant mood changes—that is opposite of gradual mood changes: Keep in mind that sudden mood changes may occur within the same mood state or between depressive and manic states
Option 1 [IF YES]—Please indicate the number of sudden, distinct, and significant mood change episodes or mood switches that you experienced yesterday. A mood switch should be counted each time your mood suddenly changes from one level to another. Keep in mind that sudden mood changes may occur within the same mood state or between depressive and manic states.
Option 2 [IF NO]—Since you indicated that you had no episodes of sudden, distinct, and significant mood changes yesterday, would you describe your mood state yesterday as

OPTION 2A—stable mood state defined as the state when you are not depressed or manic.

OPTION 2B—unstable mood state that is gradually or slowly changing over the course of previous day.

Mood Severity:

OPTION 1[IF STABLE MOOD]—You just rated your mood state for the previous day as stable. In a stable state people typically do not experience changes in sleep, ebullience or exuberance, higher or lower than normal mood, energy, sociability. So, think about yesterday and let us know if you DID experience any of the features just mentioned or any functional impairment.
IF YES—it's possible that your mood changed so gradually over the course of yesterday and you did not notice it.
IF NO—NO ACTION

OPTION 2 [IF GRADUAL MOOD CHANGE OR NOT STABLE MOOD]—You just rated your mood state for the previous day as gradually changing. Please think about the most severe or extreme point in your mood yesterday. Would you describe it as some state of depression or mania?
OPTION 2A [IF MANIC]—Please indicate how your mood has affected your ability to function yesterday by selecting your most severe level of manic mood:
   1. Severe mania—when you essentially feel incapacitated, require hospitalization or are hospitalized. IF REQUIRES MORE INFO—The state of severe mania is when you have very significant symptoms such as very decreased need for sleep or lack of sleep, significantly increased level of energy, you may feel all powerful or out of control, your thoughts and speech may be extremely rapid. And you get much insistence from your family, friends that you need medical attention, that your behavior is out of control, or they might take you to the hospital concerned that they and you cannot keep you safe any longer.
   2. High moderate mania—when you may experience great difficulty with goal-oriented activity and may get much feedback about unusual behavior. [IF REQUIRES MORE INFO]—The state of high moderate mania is when you may have very significant symptoms such as very decreased need for sleep or lack of sleep, a much increased level of energy, you may feel all powerful or out of control, your thoughts and speech may be extremely rapid. In addition, you may get much feedback from your family, friends, or coworkers that your behavior is different or difficult, expressing great concern about your ability to look after yourself or others, while other people may appear angry or frustrated with your behavior.
   3. Low moderate mania—when you may experience some difficulty with goal oriented activity and may get some feedback about unusual behavior. [IF REQUIRES MORE INFO]—The state of low moderate mania is when you may have some moderate symptoms such as decreased need for sleep, increased energy, some irritability or very elated mood, an increase in the rate of thought, speech or sociability. In addition, you may begin to be less productive and more unfocused and you may get some feedback from your family, friends, or coworkers that your behavior is different from your usual self.
   4. Mild mania or hypomania—when you may feel more energized and productive with little or no functional impairment. [IF REQUIRES MORE INFO]—The state of mild mania is when you may experience mild symptoms such as decreased need for sleep, increased energy, some irritability or very elated mood, an increase in the rate of thought, speech or sociability. Unlike low moderate mania, at the state of mild mania there might be no negative impact and might even be initial enhancement of your ability to function. Also, please indicate if your mood state for the previous day fits the conditions for dysphoric hypomania or mania. These conditions are: increase in energy, activity, rate of thinking, and interactions, with anger and irritability in the context of decreased need for sleep. In this state of depressive, unhappy or dysphoric hypomania or mania your feeling of activation is accompanied by feelings of anxiety, irritability, and anger. Lack of sense of fatigue distinguishes this state from depression.
OPTION 2B [IF DEPRESSED]—Please indicate how your mood has affected your ability to function yesterday by selecting your most severe level of depressive mood:
   1. Severe depression—when you essentially feel incapacitated and require hospitalization or are hospitalized. [IF REQUIRES MORE INFO]—The state of severe depression is when you are unable to function in any one of your usual social and occupational roles. For example, you may be unable to get out of bed, go to school or work, carry out any of your routine functions, require much extra care at home, or need to be hospitalized.
   2. High moderate depression—when you may feel marked difficulty in usual routines and that great effort is needed. [IF REQUIRES MORE INFO]—The state of high moderate depression indicates that functioning is very difficult and requires great extra time or great extra effort with very marked difficulty in your usual routines. You basically feel that you could barely scrape by.
   3. Low moderate depression—when you may feel that some extra effort is needed in usual roles. [IF REQUIRES MORE INFO]—The state of low moderate depression indicates that functioning in your usual roles is more difficult due to depressive mood symptoms and requires extra time or effort. You basically have to push yourself to get things done.
   4. Mild depression—when you may experience low mood with little or no functional impairment. [IF REQUIRES MORE INFO]—The state of mild depression represents a subjective sense of distress, a low mood, some social isolation, but you continue to function with little or no functional impairment.

OPTION 3 [IF SUDDEN/SIGNIFICANT MOOD CHANGE]—You just indicated yesterday you had [NUMBER OF EPISODES] episodes of mood changes. Did you experience these changes within the same mood state or between depressive and manic states [IF WITHIN THE SAME STATE]—would you categorize this mood state as depressed or manic?
OPTION 3A [MANIC EPISODES]—Please indicate how your mood has affected your ability to function yesterday by selecting the highest and the lowest manic mood levels for the previous day:
   1. Severe mania—when you essentially feel incapacitated and require hospitalization or are hospitalized. [IF REQUIRES MORE INFO]—The state of severe mania is when you have very significant symptoms such as very decreased need for sleep or lack of sleep, significantly increased level of energy, you may feel all powerful or out of control, your thoughts and speech may be extremely rapid. And you get much insistence from your family, friends that you need medical attention, that your behavior is out of control, or they might take you to the hospital concerned that they and you cannot keep you safe any longer.
   2. High moderate mania—when you may experience great difficulty with oriented activity and may get much feedback about unusual behavior. [IF REQUIRES MORE INFO]—The state of high moderate mania is when you may have very significant symptoms such as very decreased need for sleep or lack of sleep, a much increased level of energy, you may feel all powerful or out of control, your thoughts and speech may be extremely rapid. In addition, you may get much feedback from your family, friends, or coworkers that your behavior is different or difficult, expressing great concern about your ability to look after yourself or others, while other people may appear angry or frustrated with your behavior.
   3. Low moderate mania—when you may experience some difficulty with goal-oriented activity and may get some feedback about unusual behavior. [IF REQUIRES MORE INFO]—The state of low moderate mania is when you may have some moderate symptoms such as decreased need for sleep, increased energy, some irritability or very elated mood, an increase in the rate of thought, speech, or sociability. In addition, you may begin to be less productive and more unfocused and you may get some feedback from your family, friends, or coworkers that your behavior is different from your usual self.
   4. Mild mania or hypomania—when you may feel more energized and productive with little or no functional impairment. [IF REQUIRES MORE INFO]—The state of mild mania is when you may experience mild symptoms such as decreased need for sleep, increased energy, some irritability or very elated mood, an increase in the rate of thought, speech, or sociability. Unlike low moderate mania, at the state of mild mania there might be no negative impact and might even be initial enhancement of your ability to function

Also, please indicate if your mood state for the previous day fit the conditions for dysphoric hypomania or mania. These conditions are: increase in energy, activity, rate of thinking, and interactions, with anger and irritability in the context of decreased need for sleep. In this state of depressive, unhappy or dysphoric hypomania or mania your feeling of activation is accompanied by feelings of anxiety, irritability, and anger. Lack of sense of fatigue distinguishes this state from depression.
OPTION 3B [IF DEPRESSED EPISODES]—Please indicate how your mood has affected your ability to function yesterday by selecting the highest and the lowest depressed mood levels for the previous day::
   1. Severe depression—when you essentially feel incapacitated and require hospitalization or are hospitalized. [IF REQUIRES MORE INFO]—The state of severe depression is when you are unable to function in any one of your usual social and occupational roles. For example, you may be unable to get out of bed, go to school or work, carry out any of your routine functions, require much extra care at home, or need to be hospitalized.
   2. High moderate depression—when you may feel marked difficult in usual routines and that great effort is needed. [IF REQUIRES MORE INFO]—The state of high moderate depression indicates that functioning is very difficult and requires great extra time or great extra effort with very marked difficulty in your usual routines. You basically feel that you could barely scrape by.
   3. Low moderate depression—when you may feel that some extra effort is needed in usual roles. [IF REQUIRES MORE INFO]—The state of low moderate depression indicates that functioning in your usual roles is more difficult due to depressive mood symptoms and requires extra time or effort. You basically have to push yourself to get things done.

4. Mild depression—when you may experience low mood with little or no functional impairment. [IF REQUIRES MORE INFO]—The state of mild depression represents a subjective sense of distress, a low mood, some social isolation, but you continue to function with little or no functional impairment.
OPTION 3C [IF DEPRESSED AND MANIC]—Please indicate how your mood has affected your ability to function yesterday by selecting the highest and the lowest mood levels for the previous day. Please select your highest mood level for yesterday:
   1. Severe mania—when you essentially feel incapacitated and require hospitalization or are hospitalized. [IF REQUIRES MORE INFO]—The state of severe mania is when you have very significant symptoms such as very decreased need for sleep or lack of sleep, significantly increased level of energy, you may feel all powerful or out of control, your thoughts and speech may be extremely rapid. And you get much insistence from your family, friends that you need medical attention, that your behavior is out of control, or they might take you to the hospital concerned that they and you cannot keep you safe any longer.
   2. High moderate mania—when you may experience great difficulty with goal-oriented activity and may get much feedback about unusual behavior. [IF REQUIRES MORE INFO]—The state of high moderate mania is when you may have very significant symptoms such as very decreased need for sleep or lack of sleep, a much increased level of energy, you may feel all powerful or out of control, your thoughts and speech may be extremely rapid. In addition, you may get much feedback from your family, friends, or coworkers that your behavior is different or difficult, expressing great concern about your ability to look after yourself or others, while other people may appear angry or frustrated with your behavior.
   3. Low moderate mania—when you may experience some difficulty with goal-oriented activity and may get some feedback about unusual behavior. [IF REQUIRES MORE INFO]—The state of low moderate mania is when you may have some moderate symptoms such as decreased need for sleep, increased energy, some irritability or very elated mood, an increase in the rate of thought, speech or sociability. In addition, you may begin to be less productive and more unfocused and you may get some feedback from your family, friends, or coworkers that your behavior is different from your usual self.
   4. Mild mania or hypomania—when you may feel more energized and productive with little or no functional impairment. [IF REQUIRES MORE INFO]—The state of mild mania is when you may experience mild symptoms such as decreased need for sleep, increased energy, some irritability or very elated mood, an increase in the rate of thought, speech, or sociability. Unlike low moderate mania, at the state of mild mania there might be no negative impact and might even be initial enhancement of your ability to function
      Please select your lowest mood level for yesterday:
1. Severe depression—when you essentially feel incapacitated and require hospitalization or are hospitalized. [IF REQUIRES MORE INFO]—The state of severe depression is when you are unable to function in any one of your usual social and occupational roles. For example, you may be unable to get out of bed, go to school or work, carry out any of your routine functions, require much extra care at home, or need to be hospitalized.
2. High moderate depression—when you may feel marked difficulty in usual routines and that great effort is needed. [IF REQUIRES MORE INFO]—The state of high moderate depression indicates that functioning is very difficult and requires great extra time or great extra effort with very marked difficulty in your usual routines. You basically feel that you could barely scrape by.
3. Low moderate depression—when you may feel that some extra effort is needed in usual roles. [IF REQUIRES MORE INFO]—The state of low moderate depression indicates that functioning in your usual roles is more difficult due to depressive mood symptoms and requires extra time or effort. You basically have to push yourself to get things done.
4. Mild depression—when you may experience low mood with little or no functional impairment. [IF REQUIRES MORE INFO]—The state of mild depression represents a subjective sense of distress, a low mood, some social isolation, but you continue to function with little or no functional impairment.

Also, please indicate if your mood state for the previous day fit the conditions for dysphoric hypomania or mania. These conditions are: increase in energy, activity, rate of thinking and interactions, with anger and irritability in the context of decreased need for sleep. In this state of depressive, unhappy or dysphoric hypomania or mania your feeling of activation is accompanied by feelings of anxiety, irritability, and anger. Lack of sense of fatigue distinguishes this state from depression.

Overall Mood:

Please rate your mood for the previous day and select a number between 0 and 100, with 0 indicating most depressed ever, 50 indicating balanced, and 100 indicating most manic ever. [IF SUDDEN/SIGNIFICANT MOOD CHANGE]—Since you reported having sudden, distinct mood switches yesterday, please rate the highest and lowest moods that you experienced yesterday.

Comorbid Symptoms:

Did you experience feelings of anxiety yesterday?

Did you have panic attacks yesterday? [IF YES]—How many panic attacks did you experience yesterday?

[QUESTIONS FOR CUSTOMIZED COMORBID SYMPTOMS]

Menses:

[IF FEMALE AND MENSTRUATING] Did you have your menstrual period yesterday?

Tables VII and VIII depict a suggested event/data algorithm and associated definitions, respectively, for a bidirectional message events flow for bipolar patients.

Table IX depicts a suggested database for use with bipolar patients as illustrated in FIGS. 3A-3F.

Diabetes Patient

An embodiment of the invention for diabetes patients is herein described.

Diabetes is the fifth leading cause of death by disease in the U.S., and is associated with increased morbidity and mortality. Patients with diabetes are at higher risk for chronic conditions such as heart disease, blindness, and kidney disease. Direct medical costs associated with diabetes are estimated at $92 billion in 2002.

Although studies found strong association between diabetes treatment plan adherence and metabolic control, national adherence rates remain sub-optimal. Furthermore, non-adherence rates are higher among ethnic/racial minority and low socioeconomic status patients. Due to constraints currently facing primary care providers and state-sponsored health plans, provision of proper diabetes management care during outpatient visits is becoming increasingly difficult. This is especially relevant for Medicaid populations that are associated with limited access to care.

The extension of provider-patient communications beyond the constraints of an encounter through automated means will enhance patient adherence to diabetes treatment plans and will assist providers in monitoring their patients. Several studies reported improved adherence associated with automated telephone interventions, including low-income patients with diabetes.

In the age of increasing budget pressures, Medicaid administrators are evaluating various approaches for negotiating with pharmaceutical manufacturers. In an effort to control drug spending, states have taken various measures ranging from supplemental rebates to pharmaceutical sponsorship of value-added programs.

This embodiment optimizes a treatment plan adherence and monitoring of patients with diabetes by facilitating communication among patients, their primary care physicians, and their d health plan. Collecting and disseminating this patient information to providers results in a paradigm shift in the treatment of diabetes.

The treatment plan provides value to all parties involved in the patient management—the patient, the provider, administrators, and the state—by acting as an extension of the physician-patient dialogue. Information is provided to the patients to help them manage their diabetes, and allow them to communicate back about their condition. The active intervention consists of customized (patient-specific) bi-directional messaging via the modality of choice for each patient (i.e., landline, cellular, etc.). Patient messages provide diabetes self-management education and reminders, as well as assess treatment plan adherence. To assist physicians in managing their patients, patient self-reports are summarized and are sent back to physicians along with medication refill activity and laboratory tests.

The treatment plan is designed as a prospective, randomized, between-groups analysis. Patients are randomly assigned to a Messaged Group and Non-Messaged Group. It is believed that patients in the Messaged Group will demonstrate higher treatment plan adherence than patients in the Non-Messaged Group, due to the support of bi-directional messaging.

Plan Execution:

The treatment plan embraces the following components:
Patient enrollment and randomization
Protocol execution
Ongoing analytics and reporting
   Patient Enrollment and Randomization:

Interested patients are scheduled for a live enrollment visit with a coordinator. During the enrollment visit, coordinators obtain enrollment information and patient consents/authorizations, and distribute patient materials and cellular phones, if necessary.

Coordinators enroll eligible patients. Following patient enrollment, coordinators randomly assign the selected patients to one of two groups:
Messaged Group—active intervention group
Non-Messaged Group—control intervention group
   Protocol Execution:

Following enrollment, the patient contact begins.
Messaged Group patient intervention:
   Patients receive bi-directional messages, via phones and/or cell phones ˜3 times a week.
      Messaging provides education, reinforcements, and reminders with focus on medication adherence, glycemic testing and control, lipid testing and control, blood pressure measurement and control, eye exams, foot exams, follow-up visits, and lifestyle modifications.
      Messaging content is available in four languages: English, Spanish, Brazilian Portuguese, and Haitian Creole.
      Messaging content is customized to patient's name, gender, age, provider practice, diabetes drugs), labs (based on lab data), and any self-reported information.
      During bi-directional messaging, condition-specific information is collected directly from patients.
   Monthly qualitative surveys are delivered to and completed by patients through bi-directional messaging to assess condition status, treatment plan adherence, and quality of life.
   Patients are able to request copies of their summary progress reports by mail, fax, or web according to preference.
Non-Messaged Group patient intervention:
   Monthly qualitative surveys are delivered to and completed by patients through bi-directional messaging to assess condition status, treatment plan adherence, and quality of life.
Intervention
   Based on the guidance provided, physicians and coordinators receive the following periodic reports via preferred methods of communication:
      Activity Reports—provide patient activity status as it relates to group assignment and activity with bi-directional messaging.
      Progress Reports—provide patient self-reported, pharmacy, and labs data for each patient enrolled in Messaged Group only.
      Priority Update Reports—are generated based on patient reports requiring follow up for Messaged Group only.
   Physicians are able to request up-to-date progress reports for Messaged Group patients at any time during the program.
   Periodically physicians are asked to complete surveys related to the program experience (˜3 surveys).
      Ongoing Analytics and Reporting:

Throughout the program execution period, ongoing analyses are conducted. Summary information at an aggregate level is provided in the format of ongoing periodic reports. Outcomes are assessed using pharmacy claims data, lab data, and self-reported data collected from study participants. Qualitative information collected through surveys are also assessed.

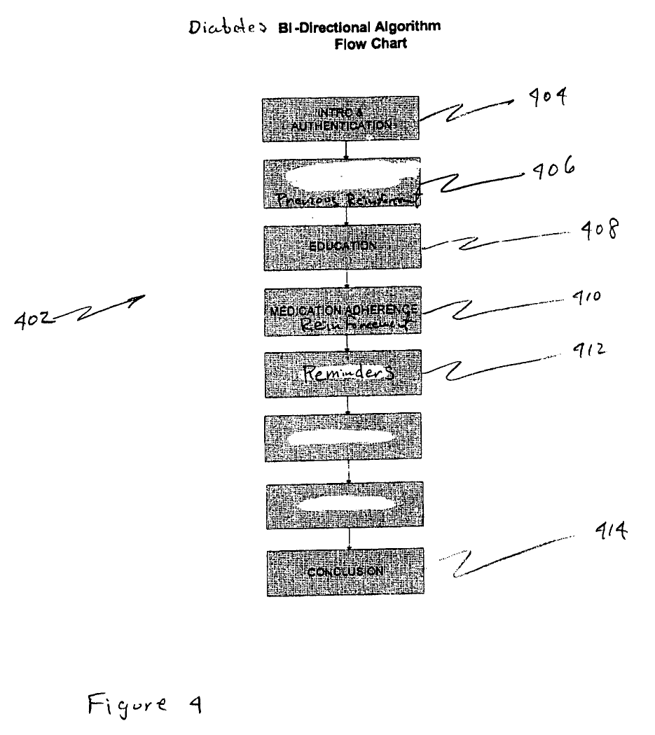

FIG. 4 is a flow diagram of the bi-directional messaging algorithm 402 used for diabetes patients. The bi-directional messaging algorithm 402 controls the sequence of questioning to the diabetes patient and, based on the patient's responses, updates the questions asked to promote a more learned protocol.

In the introduction/authentication module 404 the diabetes patient is identified via criteria as to his name, address, phone number, gender, etc. After the introduction/authentication module 404 authenticates the identity of the diabetes patient, the previous reinforcement module 406 queries the diabetes patient to address the damage that diabetes can cause to the human body.

Based on the results from the previous reinforcement module 406 the diabetes patient is then prompted to answer questions regarding the management of diabetes, including the monitoring of blood sugars via the education module 408. The education module 408 has been updated from previous contacts with the diabetes patient to not repeat the same questions, but to ask more specific questions related to the patient's particular medical condition. Thus, a customized educational tutorial is available to the diabetes patient.

The medication adherence/reinforcement module 410 stresses to the diabetes patient the importance of taking home blood sugar levels. The diabetes patient is reminded that by monitoring his blood sugar levels, both the patient and his provider can track his sugar levels and adjust his medications accordingly.

The reminders module 412 reminds the diabetes patient to get his hemoglobin A1C tested every three to six months, or as directed by his doctor. The reminders module 412 also questions the diabetes patient on the status of his medication refills. Reminders to get refills are posted, as needed.

The conclusion module 414 thanks the diabetes patient for his participation in the management of his medical condition.

An example of a bi-directional encounter for diabetes patients is listed below.

### EXAMPLE OF BI-DIRECTIONAL CALL EXERPT/PROTOCOL

Previous Reinforcement: (Module 406)

True or False: Long-term problems that diabetes can cause include damage to the heart and blood vessels, kidneys, eyes, and nerves.
OPTION #1: IF TRUE—You are right! This statement is true. It is important to keep your diabetes under control to prevent or delay some of the long-term problems of diabetes.
OPTION #2: IF FALSE—Actually, this statement is true. Diabetes is not just a problem of glucose in the blood stream. It can cause damage to the heart and blood vessels, kidneys, eyes, and nerves.
   Education: (Module 408)

Managing diabetes includes monitoring blood sugar levels and keeping them as close as possible to those of a person without diabetes. There are 2 ways to monitor your blood sugar levels. The first is by having your doctor measure your glycosylated hemoglobin, which is also known as hemoglobin A1c. The second way is by measuring your blood sugar at home.

Your hemoglobin A1c tells you what your average blood sugar level was over the past 2 to 3 months. The more sugar in the bloodstream, the higher the hemoglobin A1c. Doctors recommend measuring hemoglobin A1c every 3 to 6 months. In general, a target A1c of less than 7 percent can help you avoid the harmful complications of diabetes. A hemoglobin A1c of 7 means your average blood sugar level stayed around 150 during the past 2-3 months.
OPTION #1 [IF LAB NOT AVAILABLE FROM CHA DATA]—It looks like Doctor [DOCTOR NAME] doesn't have a record of your A1c test on file. Next time you visit Doctor [DOCTOR NAME] make sure to ask about having your hemoglobin A1c measured, because it will help keep your sugar under control.
OPTION #2 [IF LAB >7 AND PATIENT DOESN'T KNOW]—According to our last survey, you indicated that you don't know your A1c number. When Doctor [DOCTOR NAME] measured it last time, it was [CHA AIC LEVEL]. It is very important to know your hemoglobin A1c so that you will know how well you are controlling your diabetes. Next time you visit Doctor [DOCTOR NAME] make sure to discuss how you can work together to get your A1c number closer to the goal of 7.
OPTION #3 [IF LAB ≦7 AND PATIENT DOESN'T KNOW]—According to our last survey, you indicated that you don't know your A1c number. When Doctor [DOCTOR NAME] measured it last time, it was [CHA AIC LEVEL]. It is very important to know your hemoglobin A1c so that you will know how well you are controlling your diabetes. It looks like you are doing great and your A1c number is at goal. That's great, keep it up! Next time you visit Doctor [DOCTOR NAME] make sure to discuss how you can continue working together to keep your A1c number at goal of 7.
OPTION #4 [IF LAB >7 AND PATIENT KNOWS BUT IT DOESN'T MATCH]—According to our last survey, you indicated that your last A1c number is [PATIENT A1C LEVEL]. Actually, that number doesn't match with Doctor [DOCTOR NAME]'s records, which show the last A1c level of [CHA AIC LEVEL]. It is very important to know your hemoglobin A1c so that you will know how well you are controlling your diabetes. Next time you visit Doctor [DOCTOR NAME] make sure to discuss your latest test results and how you can work together to get your A1c number closer to the goal of 7.
OPTION #5 [IF LAB ≦7 AND PATIENT KNOWS BUT IT DOESN'T MATCH]—According to our last survey, you indicated that your last A1c number is [PATIENT A1C LEVEL]. Actually, that number doesn't match with Doctor [DOCTOR NAME]'s records, which show the last A1c level of [CHA AIC LEVEL]. It is very important to know your hemoglobin A1c so that you will know how well you are controlling your diabetes. Next time you visit Doctor [DOCTOR NAME] make sure to discuss your latest test results and how you can continue working together to keep your A1c number at goal of 7.
OPTION #6 [IF LAB >7 AND PATIENT KNOWS AND MATCHES]—According to our last survey, you indicated that your last A1c number is [PATIENT A1C LEVEL]. That's great that you know your A1c number! Next time you visit Doctor [DOCTOR NAME] make sure to discuss how you can work together to get your A1c number closer to the goal of 7.
OPTION #7 [IF LAB ≦7 AND PATIENT KNOWS AND MATCHES]—According to our last survey, you indicated that your last A1c number is [PATIENT A1C LEVEL]. That's great that you know your A1c number and it is at goal! Keep it up! Next time you visit Doctor [DOCTOR NAME] make sure to discuss how you can continue working together to keep your A1c number at goal of 7.
   Reinforcement: (Module 410)

True or False: If you get your blood sugar measured at home, your doctor does not need to monitor your hemoglobin A1c regularly.
OPTION #1: IF FALSE—Exactly! This statement is false. When you are measuring blood sugar levels at home, it tells what your sugar level is at the moment of measurement, helping you know what immediate effect food, exercise, stress, and medications might have on your blood sugar levels. Hemoglobin A1c provides a long view of your diabetes management by telling you what your average blood sugar level was over the past 2 to 3 months. Therefore, you need to monitor your glucose levels with both hemoglobin A1c tests and home blood glucose tests.
OPTION #2: IF TRUE—Not quite, this statement is false. When you are measuring blood sugar levels at home, it tells what your sugar level is at the moment of measurement, helping you know what immediate effect food, exercise, stress, and medications might have on your blood sugar levels. Hemoglobin A1c provides a long view of your diabetes management by telling you what your average blood sugar level was over the past 2 to 3 months. Therefore, you need to monitor your glucose levels with both hemoglobin A1c tests and home blood glucose tests.
   Reminders: (Module 412)

Don't forget to get your hemoglobin A1c tested every 3 to 6 months or as directed by your doctor.

According to your pharmacy records, you are taking the following medications to manage your diabetes—[DIABETES MEDICATIONS]. These medications will help keep your diabetes under control. Remember to take them every day as directed by your doctor.

IF DIABETES MEDICATIONS ARE DUE WITHIN TWO WEEKS—According to your pharmacy records, [DIABETES MEDICATIONS WITH REFILL DUE WITHIN 2 WEEKS] might need to be refilled within 2 weeks. Make sure you get your refills on time.

IF DIABETES MEDICATIONS ARE PAST DUE WITHIN TWO WEEKS—According to your pharmacy records you did not refill [DIABETES MEDICATIONS WITH REFILL PAST DUE ˜2 WEEKS] on time. It is important to take these medications regularly. Please select one of the following reasons for not refilling [DIABETES MEDICATION #1 WITH REFILL PAST DUE ˜2 WEEKS] on time:
You forgot to refill it
You forgot to take [DIABETES MEDICATION #1 WITH REFILL PAST DUE ˜2 WEEKS] several times in the past month and you still have some medication left from the last fill
Your doctor changed the directions on how to take it and you still have some medication left from the last fill
Your doctor told you to stop taking that medication
Your doctor gave you samples
Other reasons.
   Depression Patients

An embodiment of the invention for patients experiencing depression is described herein.

According to the latest RAND study on quality of care, Americans receive care consistent with evidence-based medicine only in 50% of the cases. This failure to deliver appropriate care results in 57,000 deaths, $1 billion in avoidable hospital costs, and 41 million lost workdays each year. These losses lead to the staggering costs of $11.5 billion for American businesses.

It is believed that an improvement in quality and appropriateness of depression care could result in averted hospitalizations, medical/psychiatric outpatient care, and work absenteeism (˜3 million work days/year) which are currently estimated at an annual cost of $44 billion to the American society.

Since 1999, HEDIS (Health Plan Employer Data and Information Set) measures related to medical management of depression and follow-up for mental health issues have remained almost stagnant. In 2002, only 60% of members in average commercial health plans were compliant with their antidepressant medication during the acute phase of treatment (first 84 days), and only 43% of members were compliant with their antidepressant medication during the continuation phase (subsequent 6 months). Furthermore, just 19% of members treated with antidepressants had at least three follow-up appointments during acute phase of treatment. The National Committee for Quality Assurance identified consumer engagement in care decisions as one of the keys to closing the “quality gap.”

It is believed that the extension of provider-patient communications beyond the constraints of an encounter through automated means will enhance patient adherence to antidepressant treatment and will assist providers in monitoring their patients.

This embodiment discloses a treatment plan using HEDIS measures related to medical management of depression by engaging targeted physicians and their consumers through an automated, interactive telephone messaging campaign.

The embodiment provides value to all parties involved in the patient management—the patient, the provider, and the health plan—by acting as an extension of the physician-patient dialogue. Information is provided to the patients to help them adhere to the antidepressant regimen. The active intervention consists of customized (patient-specific) bi-directional messaging via the phone (i.e., landline, cellular, etc.). Patient messages provide antidepressant adherence education and reminders, as well as assess treatment plan adherence. To assist physicians in managing their patients, patient self-reports are summarized and sent back to physicians along with medication refill activity.

The embodiment is designed as a prospective, randomized, between-groups analysis. Patients will be randomly assigned to a Messaged Group and Non-Messaged Group. It is believed that patients in the Messaged Group will demonstrate higher treatment plan adherence than patients in the Non-Messaged Group, due to the support of bi-directional messaging.

The embodiment targets physicians (and their corresponding group practice(s)) identified as having a considerable number patients who have discontinued antidepressant therapy during acute or continuation phase within one year prior and their affiliated insurance members that initiate new-onset antidepressant therapy.

Patient Enrollment and Randomization:

Insurance claims are reviewed periodically to target patients who were initiated on new onset antidepressant therapy by the participating physicians (Physician Intervention group). Subsequently, participating physicians are contacted (fax and reminder via phone or email) to obtain physician authorization for enrolling targeted patients. Physicians are able to authorize patient enrollment via fax, web, or phone.

Once enrolled, patients are randomized into two groups:
Messaged group (active intervention group)
Non-messaged group

A third group of patients—Control group—is identified through prescribing activity of the Physician Control group. Patients initiated on new onset antidepressant therapy by these physicians will be allocated to the control group.

Protocol Execution:

Following enrollment, the patient encounter is started. Messaged group patient intervention:
The intervention consists of a series of 3 automated personalized interactive calls (one, three, and six months after initiation of therapy).
   Patients are contacted on behalf of a provider group and/or the health plan. Content personalization and customization are based on the information maintained by the health plan (i.e., name, age, medications, etc.) and any modifications that physician might provide.
   Each call begins with confirmation and authentication of the patient.
   Messaging provides education, reinforcements, and reminders with focus on medication adherence and follow-up visits.
   Messaging content is customized to patient's name, gender, age, asthma drugs (based on information captured during enrollment), and any self-reported information.
   During bi-directional messaging, self-reported medication adherence is collected directly from patients.
   During bidirectional messaging, patients are provided access to available online, print materials, and crisis management hotline.
Non-messaged group patient intervention:
   No intervention is performed for this group
Control group patient intervention:
   No intervention is performed for this group
Physician intervention group:
   Based on the guidance provided by insurances and group practice, physicians receive periodic progress and priority reports via fax and/or reminders via preferred method of communication
   Progress reports—provide patient group assignment, response to bi-directional messaging, and pharmacy data for each patient enrolled in Messaged Group only.
   Priority reports—are generated based on patient reports requiring follow up for Messaged Group only.
   Physicians are able to request up-to-date progress reports for Messaged Group patients at any time.
   Periodically physicians are asked to complete surveys related to the treatment plan.
Physician Control group:
   No intervention is performed for this group

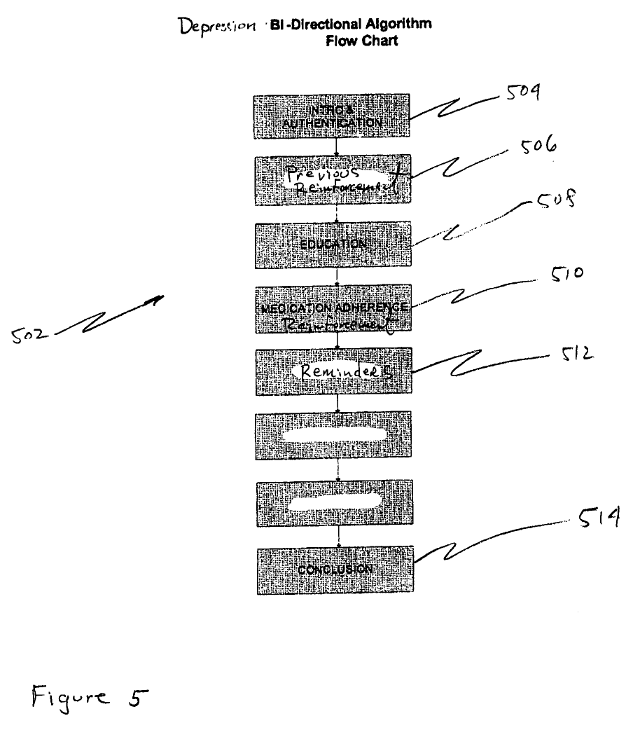

FIG. 5 is a flow diagram of the bi-directional messaging algorithm 502 used for patients experiencing depression. The bi-directional messaging algorithm 502 controls the sequence of questioning to the depression patient and, based on the patient's responses, updates the questions asked to promote a more learned protocol.

The introduction/authentication module 504, the previous reinforcement module 506, the education module 508, the medication adherence/reinforcement module 510, the reminders module 512, and the conclusion module 514 all function in the same manner as described above in FIG. 4, with one exception. The questions presented in the depression module 502 are customized for patients with depression disorders only.

It should be emphasized that the above-described embodiments of the present invention, particularly, any preferred embodiments, are merely possible examples of implementations, merely set forth for a clear understanding of the principles of the invention. Many variations and modifications may be made to the above-described embodiments of the invention without departing substantially from the spirit and principles of the invention. All such modifications and variations, are intended to be included herein within the scope of this disclosure, and the present invention and protected by the following claims.

TABLE I
Below, you will find the content and description of the flow for the
Suicide Screen section of the algorithm.

| Content/Description/Questions | Comments |
|---|---|
| The current suicide screen text reads as | |
| follows: “This is not a crisis management | |
| hotline, however because we're concerned | |
| about your safety, we'd like to ask if there | |
| were any times today when you were | |
| feeling so bad that you felt life was not | |
| worth living, when you were thinking | |
| about suicide or harming yourself?” | |
| [yes/no] | |
| If someone says “Yes”, the text reads as | |
| follows: “If you have a plan for harming | |
| yourself and urgency to do so, hang up the | |
| phone and call 911 right now. If you are | |
| having thoughts of harming yourself but do | |
| not have a plan, please contact your doctor | |
| as soon as you complete this call. If you | |
| are having rare or fleeting thoughts of | |
| harming yourself and do not have a plan, | |
| please contact your doctor if these thoughts | |
| continue.” | |
| “Press 1 to hear these instructions again, | |
| press 2 to end this call so you can contact | |
| someone, press 3 if you answered yes | |
| accidentally, press 4 to continue the call.” | |

TABLE II
Below, you will find the content and description of the flow for the
Education section of the algorithm.

| Content/Description/Questions | Comments |
|---|---|
| We are proposing playing one of the three | |
| educational messages below to the patient | |
| each time s/he goes through the call. The | |
| educational messages will rotate, so that | |
| the first time the patient calls, message 1 | |
| will play, the second time s/he calls | |
| message 2 plays, etc.; and then the rotation | |
| begins again at message 1. | |
| Are these 3 educational messages | |
| sufficient? Should we have more (or | |
| should we have fewer or not any at all)? | |
| (see the content of the messages below) | |
| Should we give the patient the option to | |
| skip these messages after they have | |
| heard them once (or some number of | |
| times) each? | |
| The text for the first educational message | |
| reads as follows: “About 1 in 3 people | |
| with bipolar disorder will remain | |
| completely free of symptoms just by taking | |
| mood stabilizing medication for life. Most | |
| other people experience a great reduction in | |
| the frequency and severity of episodes | |
| during maintenance treatment.” | |
| The text for the second educational | |
| message reads as follows: “It is important | |
| not to become overly discouraged when | |
| episodes do occur and to recognize that the | |
| success of treatment can only be evaluated | |
| over the long term, by looking at the | |
| frequency and severity of episodes. Be | |
| sure to report changes in mood to your | |
| doctor immediately, because adjustments in | |
| your medicine at the first warning signs can | |
| often restore normal mood and head off a | |
| full-blown episode.” | |
| The text for the third educational message | |
| reads as follows: “Continuing to take | |
| medication correctly and as prescribed | |
| (which is called adherence) on a long-term | |
| basis is difficult whether you are being | |
| treated for a condition such as high blood | |
| pressure, diabetes, or bipolar disorder. | |
| Individuals with bipolar disorder are often | |
| tempted to stop taking their medication | |
| during maintenance treatment for several | |
| reasons. They may feel free of symptoms | |
| and think they don't need medication | |
| anymore. They may find the side effects | |
| too hard to deal with. Or they may miss | |
| the mild euphoria they experience during | |
| hypomanic episodes. However, research | |
| clearly indicates that stopping maintenance | |
| medication almost always results in | |
| relapse, usually in weeks to months after | |
| stopping.” | |
| If someone is taking Lithium, the third | |
| educational message continues as follows: | |
| “In the case of stopping lithium, the rate of | |
| suicide rises sharply after stopping. There | |
| is some evidence that stopping lithium in | |
| an abrupt fashion carries a much greater | |
| risk of relapse. Therefore, if you must stop | |
| your medication, it should be done | |
| gradually under the close medical | |
| supervision of your doctor.” | |
| Do you have any suggestions for | |
| additional content? | |

TABLE III
Below, you will fing the content and description of the flow for the
Medication Adherence section of the algorithm.

| Content/Description/Questions | Comments |
|---|---|
| First, we confirm the name of the | |
| medication that the patient is taking. If | |
| there is a discrepancy in our records, we | |
| place the medication on “hold” (i.e., we | |
| don't ask anything more about this | |
| medication until we confirm the med with | |
| the patient's doctor) | |
| Then, we ask if the patient missed any | |
| doses yesterday. | |
| We are proposing that the patient | |
| answers about the medications that s/he | |
| took YESTERDAY as the time of the | |
| call may vary and doses may remain for | |
| the day of the call. Does this approach | |
| make sense? | |
| The number of pills taken is also tracked | |
| (this is an outcome measure for the study). | |
| Discrepancies are flagged and education is | |
| pushed depending on over or underdose | |
| and the reported reason (e.g., ran out of | |
| meds, forgot, etc.) | |
| Under what circumstances should the | |
| psychiatrist be notified? (e.g., overdose? | |
| Underdose? Zero meds taken for X | |
| days?) | |
| If a doctor should be notified, by what | |
| means? (e.g., pager, phone, fax, email). | |
| Note, we have questions about the ability | |
| to immediately reach the doctor, and the | |
| implication of a potential time delay. | |
| If a patient takes fewer pills than | |
| prescribed the following message is | |
| played: “There are a number of reasons | |
| why people may take fewer pills than they | |
| are prescribed. Press 1 if you ran out of | |
| medication. Press 2 if you forgot. Press 3 | |
| if you think you took the correct number | |
| of pills. Press 4 if you took fewer pills in | |
| an attempt to reduce side effects you were | |
| experiencing. Press 5 if you took fewer | |
| pills because you want to feel like you used | |
| to feel before you started taking | |
| medication. Press 6 if you incorrectly | |
| entered the number of pills you took.” | |
| Educational statements follow each option. | |
| If a patient takes more pills than | |
| prescribed, the following message is | |
| played: “It appears that you may have | |
| taken more than your prescribed number of | |
| pills today. Taking too many pills can have | |
| a number of serious side effects and should | |
| never be done unless your doctor has | |
| instructed you to increase your dose. If | |
| you have intentionally or accidentally | |
| overdosed on your medication and need | |
| medical assistance, please hang up and call | |
| 911 right now. If you are not sure if you | |
| have taken too many pills, please contact | |
| your doctor as soon as possible. | |
| Press 1 to hear these instructions again, | |
| press 2 to end this call so you can contact | |
| someone, press 3 if you believe you have | |
| taken the correct number of pills and have | |
| received this message in error, press 4 if | |
| you incorrectly entered the number of pills | |
| you took”, press 5 to continue.” | |
| What should we do about half pills? | |
| How common is it for a dose to entail | |
| splitting a pill? | |
| What is the maximum number of | |
| medications that should be tracked? | |
| (note that each medication that is tracked | |
| must go through the entire loop of | |
| questions regarding adherence) | |
| Should PRN medication NOT be | |
| tracked? | |
| Do we need to (how important is it to) | |
| provide education about side effects of | |
| specific medication? (options are to | |
| provide no information, to provide a | |
| generic statement about contacting doctor | |
| if experiencinge troubling side effects, to | |
| discuss the most common side effects | |
| across all drugs, to discuss the most | |
| common side effects for each individual | |
| drug, or something even more | |
| comprehensive. Keep in mind length of | |
| call) | |

TABLE IV
Below, you will find the content and description of the flow for the
Mood Rating section of the algorithm.

| Content/Description/Questions | Comments |
|---|---|
| How useful is it to tell the patient what | |
| their mood rating was the last time they | |
| did a rating? | |
| If a mood rating was not made the | |
| previous day, this message plays: “Last | |
| time, you did not make a mood rating. If | |
| possible, it is important to rate your mood | |
| every day. It will make it easier for you | |
| and [doctor name] to evaluate how well a | |
| treatment works and what is most effective | |
| in the short and long-term management of | |
| your condition.” | |
| The general mood rating statement is: | |
| “On a scale of 0 to 100, where 0 is the | |
| most depressed you could imagine being, | |
| 50 is a balanced or level mood, and 100 is | |
| the most energetic, activated, or manic you | |
| could ever be, how would you rate your | |
| mood today?” “Please enter a number | |
| between 0 and 100, followed by the # key. | |
| If you would like to hear some example | |
| ratings on the 0 to 100 scale, press 999 | |
| followed by the # key.” | |
| We are proposing that the patient | |
| answers about their mood TODAY as we | |
| believe it would be difficult to recall a | |
| mood from a previous day. Does this | |
| approach make sense? | |
| The example statement is: “Example | |
| ratings. If today you felt moderately | |
| depressed, you might rate your mood as 32 | |
| or 35, or if you felt mildly hypomanic, you | |
| might rate your mood as 54 or 57.” | |
| Are there any cases where the | |
| psychiatrist should be notified? For | |
| example, an extreme mood rating of 25 or | |
| lower or 75 or higher? (note: 50 = balanced | |
| mood, 0 = most possible | |
| depression, 100 = most possible mania) | |
| If a doctor should be notified, by what | |
| means? (e.g., pager, phone, fax, email). | |
| Note, we have questions about the ability | |
| to immediately reach the doctor, and the | |
| implication of a potential time delay. | |
| Should the psychiatrist be notified if a | |
| rating has not been made for (e.g., 7) | |
| days? If so, how many days should | |
| trigger an alert? | |

TABLE V
Below, you will fond the content and description of the flow for the
Severity Rating section of the algorithm.

| Content/Description/Questions | Comments |
|---|---|
| How useful is it to tell the patient what | |
| their severity rating was the last time | |
| they did a rating? | |
| If a severity rating was not made the | |
| previous day, this message plays: “Last | |
| time, you did not make a severity rating. If | |
| possible, it is important to rate the severity | |
| of your mood every day. It will make it | |
| easier for you and [doctor name] to | |
| evaluate how well a treatment works and | |
| what is most effective in the short and | |
| long-term management of your condition.” | |
| The general severity rating statement is: | |
| “Now we are going to ask you to rate how | |
| much your mood affected your ability to | |
| function today.” | |
| Then, based on the patients mood rating, | |
| one the following three messages is | |
| triggered: | |
| If patient rated mood 0-49: “Please rate | |
| the functional impairment that you | |
| experienced today due to your mood | |
| symptoms, which from your mood rating | |
| appear to be within the depressed to normal | |
| range.” | |
| If patient rated mood 51-100: “Please | |
| rate the functional impairment that you | |
| experienced today due to your mood | |
| symptoms, which from your mood rating | |
| appear to be within the manic to normal | |
| range.” | |
| If patient rated mood 50: “Please rate the | |
| functional impairment that you experienced | |
| today due to your mood symptoms, which | |
| from your mood rating appear to be within | |
| the normal range.” | |
| The depressed range statement is | |
| followed by the prompt: “Press 9 to hear | |
| further explanation of the levels of | |
| impairment. If you are already familiar | |
| with these levels, please make your entry | |
| now. Press 4 if you were essentially | |
| incapacitated or hospitalized, press 3 if you | |
| were functioning with great effort, press 2 | |
| if you were functioning with some effort, | |
| press 1 if you experienced little or no | |
| functional impairment, press 0 if you | |
| experienced absolutely no impairment. | |
| Please enter a number 0 through 4.” | |
| The manic range statement is followed | |
| by the prompt: | |
| “Press 9 to hear further explanation of the | |
| levels of impairment. If you are already | |
| familiar with these levels, please make | |
| your entry now. Press 4 if you were | |
| essentially incapacitated or hospitalized, | |
| press 3 if you had great difficulty with | |
| goal-oriented activity, press 2 if you had | |
| some difficulty with goal-oriented activity, | |
| press 1 if you were more energized and | |
| productive with little or no functional | |
| impairment, press 0 if you experienced | |
| absolutely no impairment. Please enter a | |
| number 0 through 4.” | |
| The example explanations for | |
| depression-related severity ratings are: | |
| “A rating of 1 indicates that you have a | |
| mild level of distress and low mood, and | |
| may experience some social isolation, | |
| however your sleep and appetite are OK, | |
| and you function well at work and at home. | |
| This rating could be called a mild | |
| depression.” | |
| “A rating of 2 indicates that your sleep and | |
| appetite have changed (increased or | |
| decreased), you may have decreased energy | |
| and concentration, you may be anxious, | |
| lack pleasure in things you do, and you | |
| may have thoughts of suicide. You feel | |
| some impairment at work and home, you | |
| may miss work, and you have to push | |
| yourself to get things done. This rating | |
| could be called a low moderate | |
| depression.” | |
| “A rating of 3 indicates that you may feel | |
| slowed down, withdrawn, and have low | |
| energy, or agitated. You have great | |
| difficulty reading or concentrating, and you | |
| may neglect your personal hygiene. You | |
| have great difficulty functioning, you rarely | |
| get to work, and you have to push yourself | |
| very hard to get things done. This rating | |
| could be called a high moderate | |
| depression.” | |
| “A rating of 4 indicates that you are | |
| immobilized and possibly mute; you can't | |
| read or concentrate, or you may be | |
| extremely agitated. You may be isolated or | |
| in bed, and you may need to go to the | |
| hospital. You are essentially incapacitated. | |
| This rating could be called a severe | |
| depression.” | |
| The example explanations for mania- | |
| related severity ratings are: | |
| “A rating of 1 indicates that you have | |
| experienced very mild symptoms such as a | |
| decrease in sleep, you are energetic, more | |
| social, and you may notice yourself talking | |
| more than usual. You experience little or | |
| no impairment, and you can be focused and | |
| productive. This rating could be called a | |
| mild level of hypomania.” | |
| “A rating of 2 indicates that you are | |
| irritable, euphoric, intrusive, and/or | |
| grandiose; you may have an increase in | |
| energy, decrease in sleep, and/or an | |
| increase in spending or phone calls. You | |
| may experience poor judgment, may be | |
| disruptive at work and home, and may have | |
| difficulty with goal-oriented activity. You | |
| are noticeably impaired and may receive | |
| feedback about your behavior from others; | |
| you are unfocused and less productive. | |
| This rating could be called a low moderate | |
| level of mania.” | |
| “A rating of 3 indicates that you may be | |
| grandiose and/or very disruptive; you may | |
| experience little or no sleep, reckless | |
| behavior, and an increase in energy and | |
| activities. You may show poor judgment, | |
| difficulty with goal-oriented activity, and | |
| you may be disruptive at work and home. | |
| It's hard to focus, you have a very hard | |
| time with your behavior and goal directed | |
| activities, and you are not productive. This | |
| rating could be called a high moderate level | |
| of mania.” | |
| “A rating of 4 indicates that you have had | |
| little or no sleep, you may experience | |
| beliefs that no one else confirms, or | |
| hallucinations. You may feel invincible or | |
| explosive. In such a state, you may need to | |
| be hospitalized and require close | |
| supervision, as your judgment is severely | |
| impaired. Others around you will insist | |
| that you go to the hospital, and you will be | |
| unable to function in any goal directed | |
| activity. This rating could be called a | |
| severe level of the manic mood state.” | |
| Are there any cases where the | |
| psychiatrist should be notified? For | |
| example, severity ratings of 3 or higher? | |
| If a doctor should be notified, by what | |
| means? (e.g., pager, phone, fax, email). | |
| Note, we have questions about the ability | |
| to immediately reach the doctor, and the | |
| implication of a potential time delay. | |
| Should the psychiatrist be notified if a | |
| rating has not been made for (e.g., 7) | |
| days? If so, how many days should | |
| trigger an alert? | |

TABLE VI
Below, you will find the content and description of the flow for the
Sleep Rating section of the algorithm.

| Content/Description/Questions | Comments |
|---|---|
| The text is: “Please enter the number of | |
| hours of sleep (rounded to the nearest hour) | |
| that you slept last night. If you slept, for | |
| example, 4.5 hours, please round to 5 | |
| hours. If you slept 4 hours and 15 minutes, | |
| round down to 4 hours. Please count only | |
| nighttime sleep and do not include naps | |
| you might have taken several hours after | |
| you got up. Please enter a number of hours | |
| of sleep now, followed by the # sign.” | |
| How important is this section? It adds | |
| length to the call. Please rate the important | |
| on a scale from 1 to 10 where 1 is not at all | |
| important and 10 is extremely important. | |

TABLE VII
Bipolar Bidirectional Messaging Events
Event and Data Algorithm
Variables:
varName (EF) - external flag variable for condition tests, provided via csv file.
varName (EX) - external string variable used within text scripts, provided via csv file.
varName (IF) - internal flag variable that needs persistance, captured locally.
varName (IX) - internal variable to be returned, captured locally and returned via csv file.
varName (IS) - internal flag variable used internally at runtime, not captured.

| | | | | | |
|---|---|---|---|---|---|
| ID | Title | Description | Actions | Needed | Collected |

INTRODUCTION (0-99)

| | | | | | |
|---|---|---|---|---|---|
| 10 | Introduction message | Hello. | Go to 20 | PatientName (EX) | |
| | | | | StudyTitle (EX) | |
| 20 | Introduction prompt | Ready? | 1 - go to 30 | PatientName (EX) | |
| | | | 2 - go to 25 | | |
| | | | 3 - go to 29 | | |
| 25 | Call back instructions | How to call back. | End call. | | CallBack (IX) |
| | message | | | | |
| 29 | Bad call message | Wrong number. | End call. | | BadCall (IX) |
| 30 | Enter ID prompt | Enter your id. | good id - go to 40 | PatientID (EF) | PatientID (IX) |
| | | | bad id - go to 39 | | |
| 35 | Call back prompt | Enter your id. | good id - go to 40 | | PatientID (IX) |
| | | | bad id - go to 39 | | |
| 39 | Invalid ID | Invalid id entered. | Go to 30 | | |
| 40 | Welcome message | Welcome. | Go to 50 | DoctorName (EX) | |
| 50 | Suicide screen | Suicide thoughts | | | |
| | message | today? | | | |
| 53 | Suicide screen prompt | Yes or no? | 1 - go to 55 | | |
| | | | 2 - go to 60 | | |
| | | | Other entries? | | |
| 55 | Suicide yes prompt | Suicide severity? | 1 - go to 55 | | Suicide (IX) |
| | | | 2 - end call | | |
| | | | 3 - go to 50 | | |
| | | | 4 - go to 60 | | |
| | | | Other entries? | | |
| 60 | Education message | Education intro. | Go to 61, 62 or 63 | | |
| | | | Need logic for this. | | |
| 61 | Education option 1 | Info message 1 | Go to 70 | | EdOp (IF) = 1 |
| | message | | | | |
| 62 | Education option 2 | Info message 2 | Go to 70 | | EdOp (IF) = 2 |
| | message | | | | |
| 63 | Education option 3 | Info message 3 | Go to 70 | | EdOp (IF) = 3 |
| | message | | | | |
| 70 | Lithium message | Placeholder | Lithium = false - go to | Lithium (EF) | |
| | | | 100 | EdOp (IF) | |
| | | | else EdOp = 3 - go to | | |
| | | | 71 | | |
| | | | else go to 72 | | |
| 71 | Lithium option 1 | Lithium info | Go to 100 | | |
| | message | | | | |
| 72 | Lithium option 2 | Lithium info | Go to 100 | | |
| | message | | | | |

MEDICINE (100-199)

| | | | | | |
|---|---|---|---|---|---|
| 100 | Med name | Placeholder | If MedNameStatus | MedNameStatus[MedNum] | |
| | check | | is ‘on hold’ - go to | (EF) | |
| | | | 180 | | |
| | | | If MedNameStatus | | |
| | | | is ‘released’ and | | |
| | | | MedNameError is | | |
| | | | ‘corrected’ - go to | | |
| | | | 102 | | |
| | | | If MedNameStatus | | |
| | | | is ‘released’ and | | |
| | | | MedNameError is | | |
| | | | ‘no error’ - go to | | |
| | | | 103 | | |
| | | | Go to 101 | | |
| 101 | Med name check | Are you | 1 - go to 110 | MedName[MedNum] (EX) | |
| | prompt | taking . . . ? | 2 - go to 105 | | |
| | | | Other entries? | | |
| 102 | Med name check | Is this correct? | 1 - go to 110 | MedName[MedNum] (EX) | |
| | update prompt | | 2 - go to 105 | | |
| | | | Other entries? | | |
| 103 | Med name check | Are you | 1 - go to 110 | MedName[MedNum] (EX) | |
| | update wrong | taking . . . ? | 2 - go to 105 | | |
| | prompt | | Other entries? | | |
| 105 | Med name check | Wrong med | Go to 180 | | MedNameStatus[MedNum] |
| | discrepancy | name. | | | (IX) - set to ‘on hold’ |
| | message | | | | |
| 110 | Med dose | Miss any | 1 - go to 120 | MedName[MedNum] (EX) | MedMissDose[MedNum] |
| | compliance | yesterday? | 2 - go to 120 | | (IX) |
| | prompt | | Other entries? | | |
| 120 | Med dose count | Placeholder | If MedCountStatus | MedCountStatus[MedNum] | |
| | logic | | is ‘on hold’ - go to | (EF) | |
| | | | 180 | | |
| | | | If MedCountStatus | | |
| | | | is ‘released’ AND | | |
| | | | MedCountError is | | |
| | | | ‘corrected’ - go to | | |
| | | | 122 | | |
| | | | If MedCountStatus | | |
| | | | is ‘released’ AND | | |
| | | | MedCountError is | | |
| | | | ‘no error’ - go to | | |
| | | | 123 | | |
| | | | Else go to 121 | | |
| 121 | Med dose count | How many pills? | Go to 124 | MedName[MedNum] (EX) | MedCount[MedNum] (IF) |
| | prompt | | | | |
| 122 | Med dose count | Corrected | Go to 121 | MedName[MedNum] (EX) | MedCount[MedNum] (IF) |
| | update message | | | MedDoseCount[MedNum] | |
| | | | | (EX) | |
| 123 | Med dose count | Please check | Go to 121 | MedName[MedNum] (EX) | MedCount[MedNum] (IF) |
| | update wrong | | | MedDoseCount[MedNum] | |
| | message | | | (EX) | |
| 124 | Med dose count | Placeholder | If MedCount is 0 | MedCount[MedNum] (IF) | |
| | check | | OR MedCount not | MedDoseCount[MedNum] | |
| | | | equal to | (EF) | |
| | | | MedDoseCount - | | |
| | | | go to 126 | | |
| | | | Else go to 125 | | |
| 125 | Med dose count | Good work. | Go to 180 | | |
| | correct message | | | | |
| 126 | Med dose count | Did doc change | 1 - go to 127 | | DoseChange[MedNum] |
| | confirm prompt | dose? | 2 - go to 128 | | (IX) |
| | | | Other entries? | | |
| 127 | Valid med dose | We're checking. | Go to 180 | | MedCountStatus[MedNum] |
| | change message | | | | (IX) (set to ‘on hold’) |
| 128 | Invalid med dose | Placeholder | If MedCount is 0 | MedCount[MedNum] (IF) | |
| | change | | OR MedCount less | MedDoseCount[MedNum] | |
| | | | than | (EF) | |
| | | | MedDoseCount - | | |
| | | | go to 140 | | |
| | | | Else go to 160 | | |
| 140 | Med number | Placeholder | If MedNumber > 1 - | MedNum (IS) | |
| | check | | go to 150 | | |
| | | | Else go to 141 | | |
| 141 | Med underdose | Why? | 1 - go to 142 | | MedUnderDose[MedNum] |
| | prompt | | 2 - go to 143 | | (IX) |
| | | | 3 - go to 144 | | |
| | | | 4 - go to 145 | | |
| | | | 5 - go to 146 | | |
| | | | 6 - go to 120 | | |
| | | | Other entries? | | |
| 142 | Med ran out | Info | Go to 148 | | |
| | message | | | | |
| 143 | Med forgot | Info | Go to 148 | | |
| | message | | | | |
| 144 | Med think correct | Info | Go to 148 | | |
| | message | | | | |
| 145 | Med reduce side | Info | If Lithium true - go | Lithium (EF) | |
| | effects message | | to 147 | | |
| | | | Else, go to 148 | | |
| 146 | Med used to feel | Info | If Lithium true - go | Lithium (EF) | |
| | message | | to 147 | | |
| | | | Else, go to 148 | | |
| 147 | Med lithium extra | Info | Go to 148 | | |
| 148 | Med zero check | Placeholder | If MedCount = 0, | | MedZero[MedNum] (IX) |
| | | | set the MedZero | | |
| | | | flag | | |
| | | | Go to 160 | | |
| 150 | Alt Med | Why? | 1 - go to 142 | | MedUnderDose[MedNum] |
| | underdose | | 2 - go to 143 | | (IX) |
| | prompt | | 3 - go to 144 | | |
| | | | 4 - go to 145 | | |
| | | | 5 - go to 146 | | |
| | | | 6 - go to 120 | | |
| | | | Other entries? | | |
| 151 | Alt Med | Info | Go to 148 | | |
| | underdose | | | | |
| | message | | | | |
| 160 | Med overdose | You overdosed. | Set MedOverdose | | MedOverdose[MedNum] |
| | prompt | | AND | | (IX) |
| | | | 1 - go to 160 | | |
| | | | 2 - end call | | |
| | | | 3 - go to 180 | | |
| | | | 4 - go to 120 | | |
| | | | 5 - go to 180 | | |
| | | | Other entries? | | |
| 180 | Med section | Placeholder | Increment | MedsTotal (EF) | |
| | loop | | MedNumber | MedNum (IS) | |
| | | | If MedNumber | | |
| | | | greater than | | |
| | | | MedsTotal - go to | | |
| | | | 200 | | |
| | | | Else, go to 100 | | |

MOOD (200-299)

| | | | | | |
|---|---|---|---|---|---|
| 200 | Mood review | Placeholder | If first contact, go | FirstTime (EF) | |
| | | | to 210 | | |
| | | | Else, go to 201 | | |
| 201 | Mood review | Review your | Go to 202 | | |
| | introduction | mood. | | | |
| | message | | | | |
| 202 | Mood review | Placeholder | If MoodMissLong | MoodMissLong (EF) | |
| | logic | | is true, go to 205 | MoodYesterday (EF) | |
| | | | If MoodYesterday | MoodLastSplit (EF) | |
| | | | is false, go to 203 | | |
| | | | If MoodLastSplit | | |
| | | | is true, go to 204 | | |
| | | | Else, go to 206 | | |
| 203 | Mood review | Need every | Go to 210 | DoctorName (EX) | |
| | option 1 | day. | | | |
| | message | | | | |
| 204 | Mood review | Last time split. | Go to 210 | MoodCycleOne (EF) | |
| | option 2 | | | MoodCycleTwo (EF) | |
| | message | | | | |
| 205 | Mood review | No rating for | Go to 210 | DoctorName (EX) | |
| | option 3 | days. | | | |
| | message | | | | |
| 206 | Mood review | Last time you | Go to 210 | MoodRatingPrev (EF) | |
| | option 4 | rated. | | | |
| | message | | | | |
| 210 | Split mood | Switching | 1 - go to 230 | | MoodSplit (IF) |
| | check | moods? | 2 - go to 220 | | |
| | prompt | | 9 - go to 215 | | |
| | | | Other - go to 219 | | |
| 215 | Mood cycle | Split examples. | Go to 210 | | |
| | examples | | | | |
| | message | | | | |
| 219 | Split mood | Problem with | Go to 210 | | |
| | check error | entry. | | | |
| | message | | | | |
| 220 | Mood input | Now you will | Go to 221 | | |
| | introduction | rate. | | | |
| | message | | | | |
| 221 | Mood input | On a scale of | Go to 222 | | |
| | message | . . . | | | |
| 222 | Mood input | How did you | 0 to 100 - go to | | MoodRating (IF) |
| | prompt | feel today? | 300 | | |
| | | | 999 - go to 225 | | |
| | | | Other entry - go to | | |
| | | | 229 | | |
| 225 | Mood input | Examples. | Go to 222 | | |
| | examples | | | | |
| | message | | | | |
| 229 | Mood input | Entry problem. | Go to 222 | | |
| | error | | | | |
| | message | | | | |
| 230 | Mood cycle | Please note | Go to 231 | | |
| | check | that . . . | | | |
| | message | | | | |
| 231 | Mood cycle | Continue with | 1 - go to 240 | | |
| | check prompt | cycle? | 2 - go to 210 | | |
| | | | Other entry - go to | | |
| | | | 239 | | |
| 239 | Mood cycle | Entry problem. | Go to 231 | | |
| | check error | | | | |
| | message | | | | |
| 240 | Mood cycle | Highest mood | 0 to 100 - go to | | MoodCycleval1 (IF) |
| | one prompt | today? | 250 | | |
| | | | Other entry - go to | | |
| | | | 249 | | |
| 249 | Mood cycle | Entry problem. | Go to 240 | | |
| | one error | | | | |
| | message | | | | |
| 250 | Mood cycle | Lowest mood | 0 to 100 - go to | | MoodCycleVal2 (IF) |
| | two prompt | today? | 260 | | |
| | | | Other entry - go to | | |
| | | | 259 | | |
| 259 | Mood cycle | Entry problem. | Go to 250 | | |
| | two error | | | | |
| | message | | | | |
| 260 | Mood cycle | Number of | 0 to 100 - go to | | MoodCycleCount (IX) |
| | count | cycles? | 300 | | |
| | prompt | | Other entry - go to | | |
| | | | 269 | | |
| 269 | Mood cycle | Entry problem. | Go to 260 | | |
| | count error | | | | |
| | message | | | | |

SEVERITY (300-399)

| | | | | | |
|---|---|---|---|---|---|
| 300 | Severity | Placeholder | If first contact, go to | FirstTime (EF) | |
| | review | | 310 | | |
| | | | Else, go to 301 | | |
| 301 | Severity review | Review | Go to 302 | | |
| | introduction | severity. | | | |
| | message | | | | |
| 302 | Severity review | Placeholder | If MoodLastSplit is | MoodLastSplit (EF) | |
| | logic | | true, go to 303 | SeverityLast (EF) | |
| | | | If SeverityLast is false, | SeverityNoCnt (EF) | |
| | | | go to 304 | | |
| | | | If SeverityNoCnt is | | |
| | | | more than 6, go to 305 | | |
| | | | Else, go to 306 | | |
| 303 | Severity review | Last time | Go to 310 | ImpairRate1 (EX) | |
| | option 1 | split. | | ImpairRate2 (EX) | |
| | message | | | | |
| 304 | Severity review | Last time | Go to 310 | DoctorName (EX) | |
| | option 2 | none. | | | |
| | message | | | | |
| 305 | Severity review | None past 7 | Go to 310 | DoctorName (EX) | |
| | option 3 | days. | | | |
| | message | | | | |
| 306 | Severity review | Last time | Go to 310 | SeverRate (EX) | |
| | option 4 | entered. | | | |
| | message | | | | |
| 310 | Severity input | Placeholder | If MoodSplit is true, go | MoodSplit (IF) | |
| | check | | to 330 | | |
| | | | Else, go to 311 | | |
| 311 | Severity input | Now rate | If MoodRating 0 to 49, | MoodRating (IF) | |
| | introduction | mood. | go to 312 | | |
| | message | | If MoodRating 51 to | | |
| | | | 100, go to 313 | | |
| | | | If MoodRating is 50, | | |
| | | | go to 314 | | |
| 312 | Severity input | Mood | Go to 315 | | |
| | low message | appears | | | |
| | | down | | | |
| 313 | Severity input | Mood | Go to 316 | | |
| | high message | appears up. | | | |
| 314 | Severity input | Mood | Go to 317 | | |
| | mid message | appears | | | |
| | | norm | | | |
| 315 | Severity input | Enter impair | 0 - go to 500 | | ImpairRate (IF) |
| | low prompt | level? | 1 to 4 - go to 321 | | ImpairType (IF) |
| | | | 9 - go to 380 | | (depressed) |
| | | | Other entry - go to 319 | | ExplainReturn (IS) |
| | | | | | (315) |
| 316 | Severity input | Enter impair | 0 - go to 500 | | ImpairRate (IF) |
| | high prompt | level? | 1 to 4 - go to 318 | | ImpairType (IF) |
| | | | 9 - go to 380 | | (manic) |
| | | | Other entry - go to 319 | | ExplainReturn (IS) |
| | | | | | (316) |
| 317 | Severity input | Enter impair | 0 - go to 500 | | ImpairRate (IF) |
| | mid prompt | level? | 1 - go to 316 | | ImpairType (IF) |
| | | | 2 - go to 315 | | (normal) |
| | | | Other entry - go to 319 | | |
| 318 | Dysphoric | Unhappy? | 1 (yes) - go to 321 | | DysphoricFlag (IX) |
| | check prompt | | 2 (no) - go to 321 | | |
| | | | Other entry (go to | | |
| | | | 320)? | | |
| 319 | Severity input | Entry | Go to 311 | | |
| | error message | problem. | | | |
| 320 | Dysphoric | Entry | Go to 318 | | |
| | check error | Problem | | | |
| | (if needed) | | | | |
| 321 | Severity flags | Placeholder | If ImpairType is manic | ImpairRate (IF) | |
| | | | AND ImpairRate is 3, | ImpairType (IF) | |
| | | | go to 322 | | |
| | | | If ImpairType is manic | | |
| | | | AND ImpairRate is 4, | | |
| | | | go to 323 | | |
| | | | If ImpairType is | | |
| | | | depressed AND | | |
| | | | ImpairRate is 3, go to | | |
| | | | 324 | | |
| | | | If ImpairType is | | |
| | | | depressed AND | | |
| | | | ImpairRate is 4, go to | | |
| | | | 325 | | |
| | | | Else, go to 500 | | |
| 322 | Severity flags | High mania. | Go to 326 | | |
| | high mania | | | | |
| | message | | | | |
| 323 | Severity flags | Severe | Go to 326 | | |
| | severe mania | mania. | | | |
| | message | | | | |
| 324 | Severity flags | High | Go to 327 | | |
| | high | depression. | | | |
| | depression | | | | |
| | message | | | | |
| 325 | Severity flags | Severe | Go to 327 | | |
| | severe | depression. | | | |
| | depression | | | | |
| | message | | | | |
| 326 | Severity flags | Severe | Go to 328 | | |
| | mania message | mania. | | | |
| 327 | Severity flags | Severe | Go to 328 | | |
| | depression | depression. | | | |
| | message | | | | |
| 328 | Severity flags | Continue? | 1 - go to 321 | | ExtremeImpair (IX) |
| | prompt | | 2 - end call | | |
| | | | 3 - 500 | | |
| | | | Other entry? | | |
| 330 | Severity input | Rate both | Go to 340 | | |
| | split message | moods. | | | |
| 340 | Split one | Placeholder | If MoodCycleVal1 is 0 | MoodCycleVal1 (IF) | |
| | severity input | | to 49, go to 341 | | |
| | | | If MoodCycleVal1 is 51 | | |
| | | | to 100, go to 342 | | |
| | | | If MoodCycleVal1 is | | |
| | | | 50, go to 343 | | |
| 341 | Split one | Mood | Go to 344 | | |
| | severity input | appears | | | |
| | low message | down | | | |
| 342 | Split one | Mood | Go to 345 | | |
| | severity input | appears up. | | | |
| | high message | | | | |
| 343 | Split one | Mood | Go to 346 | | |
| | severity input | appears | | | |
| | mid message | norm | | | |
| 344 | Split one | Enter impair | 0 - go to 360 | | ImpairRate1 (IF) |
| | severity input | level? | 1 to 4 - go to 350 | | ImpairType1 (IF) |
| | low prompt | | 9 - go to 380 | | (depressed) |
| | | | Other entry - go to 349 | | ExplainReturn (IS) |
| | | | | | (344) |
| 345 | Split one | Enter impair | 0 - go to 360 | | ImpairRate1 (IF) |
| | severity input | level? | 1 to 4 - go to 347 | | ImpairType1 (IF) |
| | high prompt | | 9 - go to 380 | | (manic) |
| | | | Other entry - go to 349 | | ExplainReturn (IS) |
| | | | | | (345) |
| 346 | Split one | Enter impair | 0 - go to 360 | | ImpairRate1 (IF) |
| | severity input | level? | 1 - go to 345 | | ImpairType1 (IF) |
| | mid prompt | | 2 - go to 344 | | (normal) |
| | | | Other entry - go to 349 | | |
| 347 | Split one | Unhappy? | 1 (yes) - go to 350 | | DysphoricFlag1 (IX) |
| | dysphoric | | 2 (no) - go to 350 | | |
| | check prompt | | Other entry? (go to | | |
| | | | 348?) | | |
| 348 | Split one | Entry | Go to 347 | | |
| | dysphoric | problem. | | | |
| | check error (if | | | | |
| | needed) | | | | |
| 349 | Split one | Entry | Go to 340 | | |
| | severity input | problem. | | | |
| | error message | | | | |
| 350 | Split one | Placeholder | If ImpairType1 is | ImpairRate1 (IF) | |
| | severity flags | | manic AND | ImpairType1 (IF) | |
| | | | ImpairRate1 is 3, go to | | |
| | | | 351 | | |
| | | | If ImpairType1 is | | |
| | | | manic AND | | |
| | | | ImpairRate1 is 4, go to | | |
| | | | 352 | | |
| | | | If ImpairType1 is | | |
| | | | depressed AND | | |
| | | | ImpairRate1 is 3, go to | | |
| | | | 353 | | |
| | | | If ImpairType1 is | | |
| | | | depressed AND | | |
| | | | ImpairRate1 is 4, go to | | |
| | | | 354 | | |
| | | | Else, go to 360 | | |
| 351 | Split one | High mania. | Go to 355 | | |
| | severity flags | | | | |
| | high mania | | | | |
| | message | | | | |
| 352 | Split one | Severe | Go to 355 | | |
| | severity flags | mania. | | | |
| | severe mania | | | | |
| | message | | | | |
| 353 | Split one | High | Go to 356 | | |
| | severity flags | depression. | | | |
| | high depression | | | | |
| | message | | | | |
| 354 | Split one | Severe | Go to 356 | | |
| | severity flags | depression. | | | |
| | severe | | | | |
| | depression | | | | |
| | message | | | | |
| 355 | Split one | Severe | Go to 357 | | |
| | severity flags | mania. | | | |
| | mania message | | | | |
| 356 | Split one | Severe | Go to 357 | | |
| | severity flags | depression. | | | |
| | depression | | | | |
| | message | | | | |
| 357 | Split one | Continue? | 1 - go to 350 | | ExtremeImpair1 (IX) |
| | severity flags | | 2 - end call | | |
| | prompt | | 3 - 360 | | |
| | | | Other entry? | | |
| 360 | Split two | Placeholder | If MoodCycleVal2 is 0 | MoodCycleVal2 (IF) | |
| | severity input | | to 49, go to 361 | | |
| | | | If MoodCycleVal2 is 51 | | |
| | | | to 100, go to 362 | | |
| | | | If MoodCycleVal2 is | | |
| | | | 50, go to 363 | | |
| 361 | Split two | Mood | Go to 364 | | |
| | severity input | appears | | | |
| | low message | down | | | |
| 362 | Split two | Mood | Go to 365 | | |
| | severity input | appears up. | | | |
| | high message | | | | |
| 363 | Split two | Mood | Go to 366 | | |
| | severity input | appears | | | |
| | mid message | norm | | | |
| 364 | Split two | Enter impair | 0 - go to 500 | | ImpairRate2 (IF) |
| | severity input | level? | 1 to 4 - go to 370 | | ImpairType2 (IF) |
| | low prompt | | 9 - go to 380 | | (depressed) |
| | | | Other entry - go to 369 | | ExplainReturn (IS) |
| | | | | | (364) |
| 365 | Split two | Enter impair | 0 - go to 500 | | ImpairRate2 (IF) |
| | severity input | level? | 1 to 4 - go to 367 | | ImpairType2 (IF) |
| | high prompt | | 9 - go to 380 | | (manic) |
| | | | Other entry - go to 369 | | ExplainReturn (IS) |
| | | | | | (365) |
| 366 | Split two | Enter impair | 0 - go to 500 | | ImpairRate2 (IF) |
| | severity input | level? | 1 - go to 365 | | ImpairType2 (IF) |
| | mid prompt | | 2 - go to 364 | | (normal) |
| | | | Other entry - go to 369 | | |
| 367 | Split two | Unhappy? | 1 (yes) - go to 370 | | DysphoricFlag2 (IX) |
| | dysphoric | | 2 (no) - go to 370 | | |
| | check prompt | | Other entry? (go to | | |
| | | | 368?) | | |
| 368 | Split two | Entry | Go to 367 | | |
| | dysphoric | problem. | | | |
| | check error | | | | |
| 369 | Split two | Entry | Go to 360 | | |
| | severity input | problem. | | | |
| | error message | | | | |
| 370 | Split two | Placeholder | If ImpairType2 is | ImpairRate2 (IF) | |
| | severity flags | | manic AND | ImpairType2 (IF) | |
| | | | ImpairRate2 is 3, go to | | |
| | | | 371 | | |
| | | | If ImpairType2 is | | |
| | | | manic AND | | |
| | | | ImpairRate2 is 4, go to | | |
| | | | 372 | | |
| | | | If ImpairType2 is | | |
| | | | depressed AND | | |
| | | | ImpairRate2 is 3, go to | | |
| | | | 373 | | |
| | | | If ImpairType2 is | | |
| | | | depressed AND | | |
| | | | ImpairRate2 is 4, go to | | |
| | | | 374 | | |
| | | | Else, go to 500 | | |
| 371 | Split one | High mania. | Go to 375 | | |
| | severity flags | | | | |
| | high mania | | | | |
| | message | | | | |
| 372 | Split one | Severe | Go to 375 | | |
| | severity flags | mania. | | | |
| | severe mania | | | | |
| | message | | | | |
| 373 | Split one | High | Go to 376 | | |
| | severity flags | depression. | | | |
| | high depression | | | | |
| | message | | | | |
| 374 | Split one | Severe | Go to 376 | | |
| | severity flags | depression. | | | |
| | severe | | | | |
| | depression | | | | |
| | message | | | | |
| 375 | Split two | Severe | Go to 377 | | |
| | severity flags | mania. | | | |
| | mania message | | | | |
| 376 | Split two | Severe | Go to 377 | | |
| | severity flags | depression. | | | |
| | depression | | | | |
| | message | | | | |
| 377 | Split two | Continue? | 1 - go to 370 | | ExtremeImpair2 (IX) |
| | severity flags | | 2 - end call | | |
| | prompt | | 3 - 500 | | |
| | | | Other entry? | | |
| 380 | Severity | Placeholder | If ImpairType is | ImpairType (IF) | |
| | explain | | depressed, go to 381 | ImpairType1 (IF) | |
| | | | Else, go to 382 | ImpairType2 (IF) | |
| 381 | Severity explain | Explain | 1 - go to 391 | ExplainReturn (IS) | |
| | depression | depression | 2 - go to 392 | | |
| | prompt | | 3 - go to 393 | | |
| | | | 4 - go to 394 | | |
| | | | 9 - go to | | |
| | | | ExplainReturn | | |
| | | | Other entry - go to 389 | | |
| 382 | Severity explain | Explain | 1 - go to 395 | ExplainReturn (IS) | |
| | mania prompt | mania | 2 - go to 396 | | |
| | | | 3 - go to 397 | | |
| | | | 4 - go to 398 | | |
| | | | 9 - go to | | |
| | | | ExplainReturn | | |
| | | | Other entry - go to 389 | | |
| 389 | Severity explain | Entry | Go to 380 | | |
| | error | problem. | | | |
| 391 | Severity explain | Explain | Go to 380 | | |
| | depression 1 | depress 1 | | | |
| | message | | | | |
| 392 | Severity explain | Explain | Go to 380 | | |
| | depression 2 | depress 2 | | | |
| | message | | | | |
| 393 | Severity explain | Explain | Go to 380 | | |
| | depression 3 | depress 3 | | | |
| | message | | | | |
| 394 | Severity explain | Explain | Go to 380 | | |
| | depression 4 | depress 4 | | | |
| | message | | | | |
| 395 | Severity explain | Explain | Go to 380 | | |
| | mania 1 | mania 1 | | | |
| | message | | | | |
| 396 | Severity explain | Explain | Go to 380 | | |
| | mania 2 | mania 2 | | | |
| | message | | | | |
| 397 | Severity explain | Explain | Go to 380 | | |
| | mania 3 | mania 3 | | | |
| | message | | | | |
| 398 | Severity explain | Explain | Go to 380 | | |
| | mania 4 | mania 4 | | | |
| | message | | | | |

SLEEP (500-599)

| | | | | | |
|---|---|---|---|---|---|
| 500 | Sleep review | Placeholder | If first contact, go to | FirstTime (EF) | |
| | | | 505 | NoSleepHours (EF) | |
| | | | If NoSleepHours is | | |
| | | | true, go to 502 | | |
| | | | Else, go to 501 | | |
| 501 | Sleep review | Yesterday's hours. | Go to 505 | SleepHours (EX) | |
| | message | | | | |
| 502 | Sleep review no | Nothing from | Go to 505 | | |
| | yesterday message | yesterday. | | | |
| 505 | Sleep review input | How many hours | 0 to 24 - go to 600 | | SleepHours (IX) |
| | prompt | sleep? | Other entry - go to | | |
| | | | 509 | | |
| 509 | Sleep review input | Entry problem. | Go to 505 | | |
| | error message | | | | |

CONCLUSION (600-699)

| | | | | |
|---|---|---|---|---|
| 600 | Conclusion message | Thanks & goodbye. | End call | DoctorName (EX) |

TABLE VIII
Variable definitions
Variables:
varName (EF) - external flag variable for condition tests, provided via csv file.
varName (EX) - external string variable used within text scripts, provided via csv file.
varName (IF) - internal flag variable that needs persistance, captured locally.
varName (IX) - internal variable to be returned, captured locally and returned via csv file.
varName (IS) - internal flag variable used internally at runtime, not captured.
PAR3 variables are shaded.

| Name | Description | Type | Who | Needed | Collected |
|---|---|---|---|---|---|
| PatientName (EX) | Name of patient. Used in message. | Text | Redmon | 10, 20 | |
| StudyTitle (EX) | Name of study. Used in message. | Text | Redmon | 10 | |
| CallBack (IX) | Identifies a patient that will call back | Boolean | PAR3 | | 25 |
| | at a later time. | | | | |
| BadCall (IX) | Identifies a bad call such as a wrong | Boolean | PAR3 | | 29 |
| | number. | | | | |
| PatientID (EF) | Patient identifier used to check for | Text | Redmon | 30 | |
| | correct call. | | | | |
| PatientID (IX) | Patient identifier collected to identify | Text | PAR3 | | 35 |
| | the patient that is calling back. | | | | |
| DoctorName (EX) | Name of patient's doctor. Used in | Text | Redmon | 40, 203, | |
| | message. | | | 205, 304, | |
| | | | | 305, 600 | |
| Suicide (IX) | Indicates suicide plan. | Boolean | PAR3 | | 55 |
| | This flag should alert an | | | | |
| | administrator. | | | | |
| EdOp (IF) | Indicates the education option | Integer | PAR3 | 70 | 61, 62, 63 |
| | played. | | | | |
| Lithium (EF) | Indicates that the patient is on | Boolean | Redmon | 70, 145, | |
| | Lithium. Obtain from patient data. | | | 146 | |
| MedNum (IS) | This is a special counter that | Integer | PAR3 | 140, 180 | |
| | identifies which medicine is being | | | | |
| | questioned. It is used to identify | | | | |
| | many of the following variables. | | | | |
| | This is a special variable that is | | | | |
| | only used during the telephone | | | | |
| | call. | | | | |
| MedNameStatus[MedNum] (EF) | Indicates the status of the current | Integer | Redmon | 100 | |
| | medicine being questioned. On | | | | |
| | hold, released with error corrected, | | | | |
| | released with no error or normal. | | | | |
| | This value is collected by PAR3 and | | | | |
| | can be changed by administrators | | | | |
| | before being returned to PAR3 in a | | | | |
| | future session. | | | | |
| MedNameStatus[MedNum] (IX) | Same variable as above. Indicates | Integer | PAR3 | | 105 |
| | the status of the current medicine | | | | |
| | being questioned. Set to ‘On hold’ if | | | | |
| | this item is used. | | | | |
| MedName[MedNum] (EX) | Name of the medicine used in the | Text | Redmon | 101, 102, | |
| | message. | | | 103, 110, | |
| | | | | 121, 122, | |
| | | | | 123 | |
| MedMissDose[MedNum] (IX) | Indicates that the patient missed this | Boolean | PAR3 | | 110 |
| | medication yesterday. | | | | |
| MedCountStatus[MedNum] (EF) | Indicates the status of the count of | Integer | Redmon | 120 | |
| | the current medicine being | | | | |
| | questioned. On hold, released with | | | | |
| | error corrected, released with no | | | | |
| | error or normal. This value is | | | | |
| | collected by PAR3 and can be | | | | |
| | changed by administrators before | | | | |
| | being returned to PAR3 in a future | | | | |
| | session. | | | | |
| MedCountStatus[MedNum] (IX) | Same variable as above. Indicates | Integer | PAR3 | | 127 |
| | the status of the count of the current | | | | |
| | medicine being questioned. Set to | | | | |
| | ‘On hold’ if this item is used. | | | | |
| MedCount[MedNum] (IF) | Patient's response to the number of | Integer | PAR3 | 124, 128 | 121, 122, |
| | pills taken for this medication. | | | | 123 |
| MedDoseCount[MedNum] (EX) | Dosage for this medication for this | Text | Redmon | 122, 123 | |
| | patient on file. | | | | |
| | This value is used in the message | | | | |
| | as opposed to a comparison. | | | | |
| | Should this be a different variable | | | | |
| | than the one below? | | | | |
| MedDoseCount[MedNum] (EF) | Dosage for this medication for this | Integer | Redmon | 124, 128 | |
| | patient on file. This is the same | | | | |
| | variable as the one above, but used | | | | |
| | in a different context. | | | | |
| | See above. | | | | |
| DoseChange[MedNum] (IX) | Is this a valid dose change? Set to | Boolean | PAR3 | | 126 |
| | true is the patient thinks their doctor | | | | |
| | changed their dose for this | | | | |
| | medication. Redmon will need to | | | | |
| | flag the administrator of this | | | | |
| | condition. | | | | |
| MedUnderDose[MedNum] (IX) | Indicates that the patient did not take | Boolean | PAR3 | | 141, 150 |
| | enough of this medication yesterday. | | | | |
| MedZero[MedNum] (IX) | Indicates that the patient did not take | Boolean | PAR3 | | 148 |
| | any of this medication yesterday. | | | | |
| MedOverdose[MedNum] (IX) | Indicates that the patient took too | Boolean | PAR3 | | 160 |
| | much of this medication yesterday. | | | | |
| MedsTotal (EF) | Indicates the total number of | Integer | Redmon | 180 | |
| | medicines being tracked. | | | | |
| FirstTime (EF) | Indicates that this the first time that | Boolean | Redmon | 200, 300, | |
| | the patient is using this system. | | | 500 | |
| MoodMissLong (EF) | Indicates that the patient has not | Boolean | Redmon | 202 | |
| | given a mood scale for 7 days. | | | | |
| MoodYesterday (EF) | Indicates if the patient entered mood | Boolean | Redmon | 202 | |
| | information yesterday. | | | | |
| MoodLastSplit (EF) | Indicates that the last mood rating | Boolean | Redmon | 202, 302 | |
| | was a split mood. | | | | |
| MoodCycleOne (EF) | Yesterday's mood cycle one rating | Integer | Redmon | 204 | |
| | (collected from MoodCycleVal1 | | | | |
| | yesterday). | | | | |
| MoodCycleTwo (EF) | Yesterday's mood cycle two rating | Integer | Redmon | 204 | |
| | (collected from MoodCycleVal2 | | | | |
| | yesterday). | | | | |
| MoodRatingPrev (EF) | Yesterday's mood rating for a non- | Integer | Redmon | 206 | |
| | split cycle (collected from | | | | |
| | MoodRating yesterday). | | | | |
| MoodSplit (IF) | Indicates if the patient had split | Boolean | PAR3 | 310 | 210 |
| | moods. | | | | |
| MoodRating (IF) | Mood rating by the patient for a non- | Integer | PAR3 | 311 | 222 |
| | split cycle. Value of 0 to 100. | | | | |
| MoodCycleVal1 (IF) | Highest mood for the patient in a | Integer | PAR3 | 340 | 240 |
| | split cycle. Value of 0 to 100. | | | | |
| MoodCycleVal2 (IF) | Lowest mood for the patient in a split | Integer | PAR3 | 360 | 250 |
| | cycle. Value of 0 to 100. | | | | |
| MoodCycleCount (IX) | Number of cycles for the patient in a | Integer | PAR3 | | 260 |
| | split cycle. Value of 0 to 100. | | | | |
| SeverityLast (EF) | Indicates if the patient made a | Boolean | Redmon | 302 | |
| | severity rating during the last | | | | |
| | session. | | | | |
| SeverityNoCnt (EF) | Count of consecutive days without a | Integer | Redmon | 302 | |
| | severity rating for this patient. | | | | |
| ImpairRate1 (EX) | The collected imparement rate | Integer | Redmon | 303 | |
| | (ImpairRate1) from yesterday's data. | | | | |
| | Used in the message. | | | | |
| ImpairRate2 (EX) | The collected imparement rate | Integer | Redmon | 303 | |
| | (ImpairRate2) from yesterday's data. | | | | |
| | Used in the message. | | | | |
| SeverRate (EX) | The collected severity rate | Integer | Redmon | 306 | |
| | (SeverRate) from yesterday's data. | | | | |
| | Used in the message. | | | | |
| ImpairRate (IF) | The level of impairment (1 to 4). | Integer | PAR3 | 321 | 315, 316, |
| | This will combine with the imparity | | | | 317 |
| | type to determine the actual impairity | | | | |
| | level. | | | | |
| ImpairType (IF) | The type of impairment, depressed, | Integer | PAR3 | 321, 380 | 315, 316, |
| | manic or normal. | | | | 317 |
| ExplainReturn (IS) | This is an item identifier to mark the | Integer | PAR3 | 381, 382 | 315, 316, |
| | return point from another section of | | | | 317, 344, |
| | the call (the examples). | | | | 345, 364, |
| | This is another special variable | | | | 365 |
| | that is only used during the | | | | |
| | telephone call. | | | | |
| DysphoricFlag (IX) | This is a flag that is captured to | Boolean | PAR3 | | 318 |
| | indicate the the patient was feeling | | | | |
| | unhappy. | | | | |
| ExtremeImpair (IX) | Indicates that this patient is | Boolean | PAR3 | | 328 |
| | experiencing extreme impairment. | | | | |
| | This flag should alert an | | | | |
| | administrator. | | | | |
| ImpairRate1 (IF) | The level of impairment (1 to 4) for | Integer | PAR3 | 350 | 344, 345 |
| | the first split mood. This will | | | | 346 |
| | combine with the imparity type for | | | | |
| | the first split mood to determine the | | | | |
| | actual impairity level for the first split | | | | |
| | mood. | | | | |
| ImpairType1 (IF) | The type of impairment for the first | Integer | PAR3 | 350, 380 | 344, 345, |
| | split mood, depressed, manic or | | | | 346 |
| | normal. | | | | |
| DysphoricFlag1 (IX) | This is a flag that is captured to | Boolean | PAR3 | | 347 |
| | indicate the the patient was feeling | | | | |
| | unhappy for the first split mood. | | | | |
| ExtremeImpair1 (IX) | Indicates that this patient is | Boolean | PAR3 | | 357 |
| | experiencing extreme impairment for | | | | |
| | the first split mood. | | | | |
| | This flag should alert an | | | | |
| | administrator. | | | | |
| ImpairRate2 (IF) | The level of impairment (1 to 4) for | Integer | PAR3 | 370 | 364, 365, |
| | the second split mood. This will | | | | 366 |
| | combine with the imparity type for | | | | |
| | the second split mood to determine | | | | |
| | the actual impairity level for the | | | | |
| | second split mood. | | | | |
| ImpairType2 (IF) | The type of impairment for the | Integer | PAR3 | 370, 380 | 364, 365, |
| | second split mood, depressed, | | | | 366 |
| | manic or normal. | | | | |
| DysphoricFlag2 (IX) | This is a flag that is captured to | Boolean | PAR3 | | 367 |
| | indicate the the patient was feeling | | | | |
| | unhappy for the second split mood. | | | | |
| ExtremeImpair2 (IX) | Indicates that this patient is | Boolean | PAR3 | | 377 |
| | experiencing extreme impairment for | | | | |
| | the second split mood. | | | | |
| | This flag should alert an | | | | |
| | administrator. | | | | |
| NoSleepHours (EF) | Indicates if the patient responded to | Boolean | Redmon | 500 | |
| | the sleep hours question yesterday. | | | | |
| SleepHoursPrev (EX) | The number of sleep hours that the | Integer | Redmon | 501 | |
| | patient indicated yesterday. Used in | | | | |
| | the message. | | | | |
| SleepHours (IX) | The number of sleep hours that the | Integer | PAR3 | | 505 |
| | patient received last night. | | | | |

TABLE IX
USiP Bipolar Database Definition Document

Database Overview

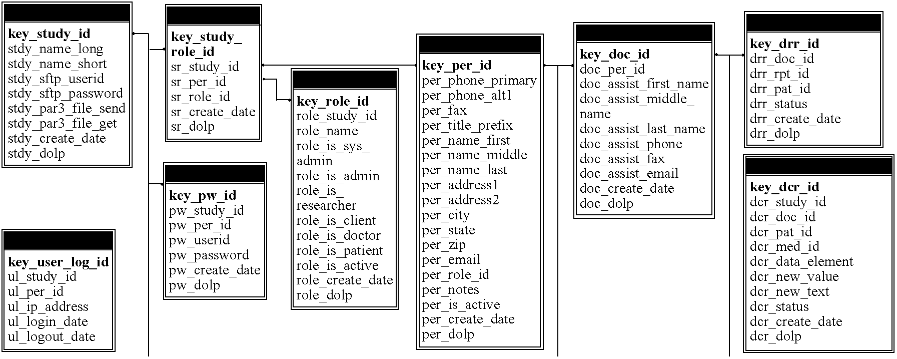

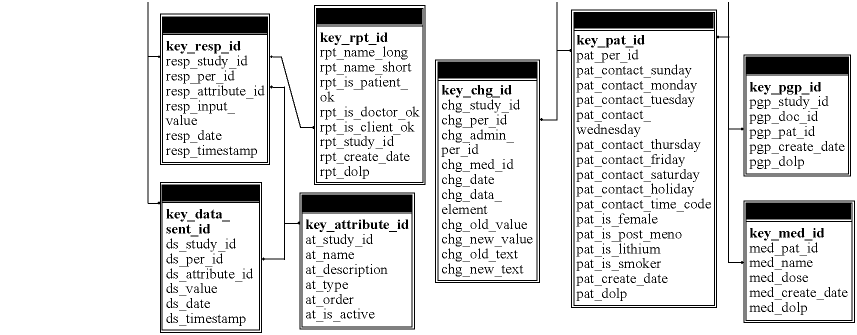

Entire database overview with major relationships (enforced through code only)

USiP Bipolar Table Definitions
Attributes
This table holds the attributes for the studies. An attribute is a variable collected from PAR3 through their telephone
survey system or a variable sent back to PAR3. Each study will have its own set of attributes. The attribute key value is
used to identify these values in the responses and data_sent tables.

| Name | Type | Size | Description |
|---|---|---|---|
| key_attribute_id | int | 4 | Key for this table of attributes. |
| at_study_id | int | 4 | Identifies the study that this attribute is used for. |
| at_name | varchar | 100 | This is the name of the attribute, also known as the variable name. |
| at_description | text | 16 | Description of the attribute. |
| at_type | smallint | 2 | Type of attribute. 0 for outgoing (sent from USIP), 1 for incomming (sent to USIP), |
| at_order | int | 4 | Order that the attributes should display in the PAR3 file headers. |
| at_is_active | bit | 1 | Is this attribute currently active within the system? |

USip Bipolar Project - DRAFT

ChangeTrack
This table holds a record of all of the administrative changes to users within the system. The current information is stored
in the main tables while all changes are logged to this table. An administrative change history is contained in this table
along with the time and date that the changes occurred.

| Name | Type | Size | Description |
|---|---|---|---|
| key_chg_id | int | 4 | Key for this table that tracks changes made within the system. |
| chg_study_id | int | 4 | Study identifier for this change. |
| chg_per_id | int | 4 | Person identifier that is making this change. |
| chg_admin_per_id | int | 4 | Person identifier for the administrator makin this change. |
| chg_med_id | int | 4 | Medication id, used if this change is associated with a medication. |
| chg_date | datetime | 8 | Date and time that the change was made. |
| chg_data_element | varchar | 100 | Name of the data element (database field) that changed. |
| chg_old_value | varchar | 250 | Old value before the change occurred. |
| chg_new_value | varchar | 250 | New value after the change occurred. |
| chg_old_text | text | 16 | Old value before the change occurred. This is used for text fields such as notes. |
| chg_new_text | text | 16 | New value after the change occurred. This is used for text fields such as notes. |

Data_sent
This is an archive table that holds all of the data that is passed to PAR3 in data files to drive the telephone questionnaires.
Even though the data files will serve as the primary backup of transmitted information, this data will provide an easy
means of looking up specific data if necessary.

| Name | Type | Size | Description |
|---|---|---|---|
| key_data_sent_id | int | 4 | Key for this table of data sent to PAR3. |
| ds_study_id | int | 4 | Study identifier for this record. |
| ds_person_id | int | 4 | Person identifier for this record. |
| ds_attribute_id | int | 4 | Identifies the attribute for this record. |
| ds_value | varchar | 100 | Value of this attribute for this person for this study. |
| ds_date | datetime | 8 | Date to which this record applies. |
| ds_timestamp | datetime | 8 | Time that this record was added to the database. |

Doctor
This table holds additional doctor specific information in addition to the information held in the person table.

| Name | Type | Size | Description |
|---|---|---|---|
| key_doc_id | int | 4 | Key for this table of doctor specific information. |
| doc_per_id | int | 4 | Person identifier. |
| doc_assist_first_name | varchar | 250 | Assistant first name. |
| doc_assist_middle_name | varchar | 250 | Assistant middle name. |
| doc_assist_last_name | varchar | 250 | Assistant last name. |
| doc_assist_phone | varchar | 50 | Assistant phone number. |
| doc_assist_fax | varchar | 50 | Assistant FAX number. |
| doc_assist_email | varchar | 250 | Assistant email address. |
| doc_create_date | datetime | 8 | Date this record was created. |
| doc_dolp | datetime | 8 | Date this record was last changed. |

DoctorChangeRequest
This table holds a log of requests from doctors to change patient information. The doctors can request changes through
the interface and the requests are logged here. This table will be used to build the change approval form used by the
researchers and administrators to make the actual changes to the person, patient or medications tables.

| Name | Type | Size | Description |
|---|---|---|---|
| key_dcr_id | int | 4 | Key for this table logging patient change requests from doctors. |
| dcr_study_id | int | 4 | Study identifier for this change request. |
| dcr_psy_id | int | 4 | Doctor identifier. |
| dcr_pat_id | int | 4 | Patient identifier. |
| dcr_med_id | int | 4 | Medication identifier used if this change refers to a medication for this patient. |
| dcr_data_element | varchar | 100 | Name of the data element (database field) for this change request. |
| dcr_new_value | varchar | 250 | New value requested. |
| dcr_new_text | text | 16 | New value requested. This is used if this is for the notes field. |
| dcr_status | int | 4 | Status of the request (0-requested, 1-accepted, 2-rejected). |
| dcr_create_date | datetime | 8 | Date this record was created. |
| dcr_dolp | datetime | 8 | Date this record was last changed. |

DoctorReportRequest
This table holds a log of requests from doctors to obtain reports. The doctors can request reports through the interface
and the requests are logged here. This table will be used to build the report generation and printing form used by the
researchers and administrators to print the forms so that they can be faxed to the doctors.

| Name | Type | Size | Description |
|---|---|---|---|
| key_drr_id | int | 4 | Key for this table that logs doctors report requests. |
| drr_doc_id | int | 4 | Doctor identifier. |
| drr_rpt_id | int | 4 | Report identifier. |
| drr_pat_id | int | 4 | Patient identifier (not needed for all reports, −1 if unused). |
| drr_status | int | 4 | Status of the request (0-requested, 1-printed). |
| drr_create_date | datetime | 8 | Date this record was created. |
| drr_dolp | datetime | 8 | Date this record was last changed. |

Medications
This table holds all of the patient medication information such as name and dosage. A patient can have many
medications.

| Name | Type | Size | Description |
|---|---|---|---|
| key_med_id | int | 4 | Key for this table of medication used by patients. |
| med_pat_id | int | 4 | Patient identifier for these medications. |
| med_name | int | 4 | Name of this medication. |
| med_dose | varchar | 250 | Daily dosage for this medication for this patient. |
| med_create_date | datetime | 8 | Date that this record was created. |
| med_dolp | datetime | 8 | Date of last post. |

Password
This table contains the userid and password information for all users. This table is checked during login for valid entries.

| Name | Type | Size | Description |
|---|---|---|---|
| key_pw_id | int | 4 | Key for this table of user names and passwords. |
| pw_study_id | int | 4 | Study identifier. |
| pw_er_id | int | 4 | Person identifier. |
| pw_userid | varchar | 100 | Username. |
| pw_password | varchar | 100 | Password. |
| pw_create_date | datetime | 8 | Date that this record was created. |
| pw_dolp | datetime | 8 | Date of last post. |

Patient
This table contains patient specific information and contact preferences. This is in addition to the person information for
all users. This table will use an insert trigger to return the key id for inserted records.

| Name | Type | Size | Description |
|---|---|---|---|
| key_pat_id | int | 4 | Key for this table of patient preference information. |
| pat_per_id | int | 4 | Person identifier for this patient. |
| pat_contact_sunday | bit | 1 | Contact this patient on Sunday? |
| pat_contact_monday | bit | 1 | Contact this patient on Monday? |
| pat_contact_tuesday | bit | 1 | Contact this patient on Tuesday? |
| pat_contact_wednesday | bit | 1 | Contact this patient on Wednesday? |
| pat_contact_thursday | bit | 1 | Contact this patient on Thursday? |
| pat_contact_friday | bit | 1 | Contact this patient on Friday? |
| pat_contact_saturday | bit | 1 | Contact this patient on Saturday? |
| pat_contact_holiday | bit | 1 | Contact this patient on holidays? |
| pat_contact_time_code | int | 4 | Time block to contact this patient. 1-morning, 2-afternoon, 3-evening |
| pat_is_female | bit | 1 | Is this patient female? |
| pat_is_post_meno | bit | 1 | Is this patient post menopausal? |
| pat_is_lithium | bit | 1 | Is this patient taking Lithium? |
| pat_create_date | datetime | 8 | Date this record was created. |
| pat_dolp | datetime | 8 | Date this record was last changed. |

PatientGroup
This table groups the patients to the doctors for a given study. This data would be used to identify a patient's doctor or to
identify the patients under a specific doctor.

| Name | Type | Size | Descnption |
|---|---|---|---|
| key_pgp_id | int | 4 | Key for this table that groups patients to doctors and studies. |
| pgp_study_id | int | 4 | Study identifier for this patient. |
| pgp_doc_id | int | 4 | Doctor for this patient in this study. |
| pgp_pat_id | int | 4 | Patient person identifier. |
| pgp_create_date | datetime | 8 | Date this record was created. |
| pgp_dolp | datetime | 8 | Date this record was last changed. |

Person
This table contains the base information for all users within the system. This table will use an insert trigger to return the key id for inserted records.

| Name | Type | Size | Description |
|---|---|---|---|
| key_per_id | int | 4 | Key for this table of all persons. |
| per_phone_primary | varchar | 50 | Main phone number. |
| per_phone_alt1 | varchar | 50 | Alternate phone number. |
| per_fax | varchar | 50 | FAX number. |
| per_title_prefix | Varchar | 10 | Prefix for ther name (Mr., Ms., Dr., etc.) |
| per_name_first | varchar | 250 | First name. |
| per_name_middle | varchar | 250 | Middle name. |
| per_name_last | varchar | 250 | Last name. |
| per_address1 | varchar | 250 | Address line 1. |
| per_address2 | varchar | 250 | Address line 2. |
| per_city | varchar | 250 | City |
| per_state | varchar | 250 | State |
| per_zip | varchar | 20 | Zip code |
| per_email | varchar | 250 | Email address for this person. |
| per_role_id | int | 4 | Role identifier that will identify this person's role in this study. |
| per_notes | text | 16 | Administrative notes about this person. |
| per_is_active | bit | 1 | Is this person currently active? |
| per_create_date | datetime | 8 | Date this record was created. |
| per_dolp | datetime | 8 | Date this record was last changed. |

Report
This table hold the report information for specific reports within the studies. This data is used to provide listings for report
selections within the interface.

| Name | Type | Size | Description |
|---|---|---|---|
| key_rpt_id | int | 4 | Key for this table of reports. |
| rpt_name_long | varchar | 250 | Long name for this report. Used for complete identification of this report within displays. |
| rpt_name_short | varchar | 100 | Short name for this report. |
| rpt_is_patient_ok | bit | 1 | Is this report available to the patient? |
| rpt_is_doctor_ok | bit | 1 | Is this report available to the doctor? |
| rpt_is_client_ok | bit | 1 | Is this report available to the client? |
| rpt_study_id | int | 4 | Study identifier for this report. |
| rpt_create_date | datetime | 8 | Date this record was created. |
| rpt_dolp | datetime | 8 | Date this record was last changed. |

Responses
This table holds the patient responses to the PAR3 telephone query system. This data will be used to build reports and to
help in building some of the data transmitted to PAR3.

| Name | Type | Size | Description |
|---|---|---|---|
| key_resp_id | int | 4 | Key for this table. |
| resp_study_id | int | 4 | Study identifier for this response. |
| resp_per_id | int | 4 | Person identifier for this response. |
| resp_attribute_id | int | 4 | Attribute identifier for this response. |
| resp_input_value | varchar | 100 | Response value. Only boolean and integers are collected. Boolean can be 1/0 for T/F. |
| resp_date | datetime | 8 | Date that this response was made. Note: this may be different from the recorded date. |
| resp_timestamp | datetime | 8 | Date and time that this response was recorded. This is the time that the data is processed from PAR3. |

Role
This table identifies the roles of the various users within the system. It also identifies any crossover between roles, such
as admins may also have researcher privileges. This strategy could be used to create special customized roles.

| Name | Type | Size | Description |
|---|---|---|---|
| key_role_id | int | 4 | Key for this table of person roles within the studies. |
| role_study_id | int | 4 | Study identifier where this role will be used. |
| role_name | varchar | 100 | Name of this role for listings. |
| role_is_sys_admin | bit | 1 | Does this role have systems administrator privileges? |
| role_is_admin | bit | 1 | Does this role have administrator privileges? |
| role_is_researcher | bit | 1 | Does this role have researcher privileges? |
| role_is_client | bit | 1 | Does this role have client privileges? |
| role_is_doctor | bit | 1 | Does this role have doctor privileges? |
| role_is_patient | bit | 1 | Does this role have patient privileges? |
| role_is_active | bit | 1 | Is this a currently active role for this study. |
| role_create_date | datetime | 8 | Date this record was created. |
| role_dolp | datetime | 8 | Date this record was last changed. |

Study
This table contains the study specific information. There should be one record per study.

| Name | Type | Size | Description |
|---|---|---|---|
| key_study_id | int | 4 | Key for this table of studies. |
| stdy_name_long | varchar | 250 | Long name for this study. Formal name. |
| stdy_name_short | varchar | 100 | Short name for this study. |
| stdy_sftp_userid | varchar | 100 | Secure FTP transfer user name. |
| stdy_sftp_password | varchar | 100 | Secure FTP transfer password. |
| stdy_par3_file_send | varchar | 250 | Name of file to send to PAR3. |
| stdy_par3_file_get | varchar | 250 | Name of file to retreive from PAR3. |
| stdy_create_date | datetime | 8 | Date this record was created. |
| stdy_dolp | datetime | 8 | Date this record was last changed. |

Study_roles
This table identifies the user's roles in the context of a study. A person may have different roles in different studies.

| Name | Type | Size | Description |
|---|---|---|---|
| key_study_role_id | int | 4 | Key for this table of roles for this study. |
| sr_study_id | int | 4 | Study identifier for this role. |
| sr_per_id | int | 4 | Person for this role for this study. |
| sr_role_id | int | 4 | Role identifier. |
| sr_create_date | datetime | 8 | Date this record was created. |
| sr_dolp | datetime | 8 | Date this record was last changed. |

User_log
This table tracks all users logging into the system. If users use the logout button, then we can also track the user logouts.

| Name | Type | Size | Description |
|---|---|---|---|
| key_user_log_id | int | 4 | Key for this table of user logins. |
| ul_study_id | int | 4 | Study identifier for this login. |
| ul_per_id | int | 4 | Person for this login. |
| ul_login_date | datetime | 8 | Date and time this user logged in. |
| ul_logout_date | datetime | 8 | Date and time this user logged out (may not be available. |

Major Table Relationships
Login authenticate, get user name and password:
The entered username and password are checked against the password table records for the specific study. A
successful match can will identify the person and role for this study. Successful logins will be logged to the user_log table.

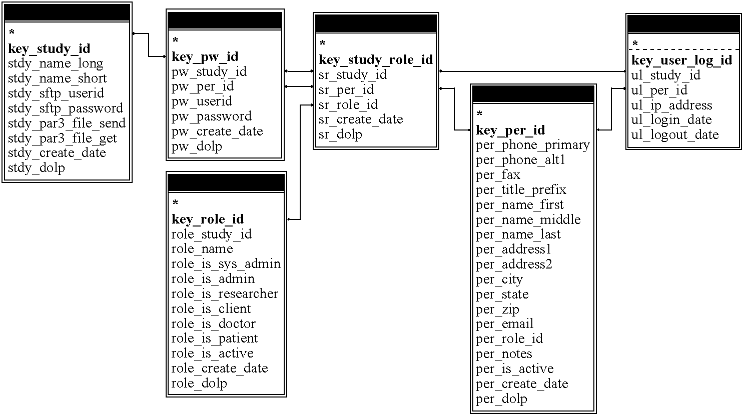

Patient information:
Using the person id, this will obtain all of the patient information, including the doctor's name. This will probably be
created as a view to join the person, patient, patient_group, doctor and medications information into a single view. These
relationships can also be used to get the patient preferences.

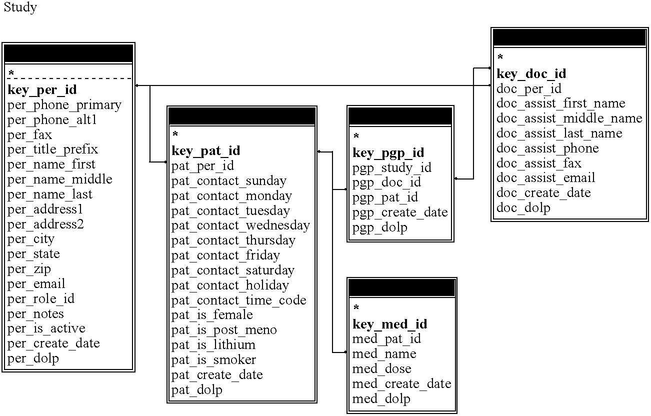

User information:
These relationships can be used to gather information about any of the system users. A person can be identified by role
for a given study. A list of patients for a given doctor or a list of doctors for a given study can be obtained. These
relationships will also handle the doctor's patient information change requests and administrative processing of the requests.

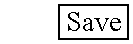

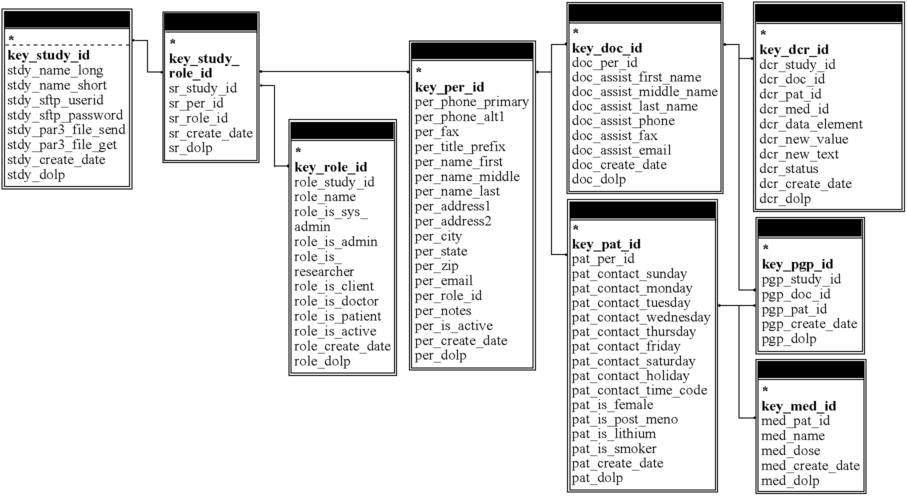

Telephone Interactions and reporting:
These relationships will allow the telephone data file interactions to be stored and recalled for use in building reports. The
transfer passwords and file names are also available here.

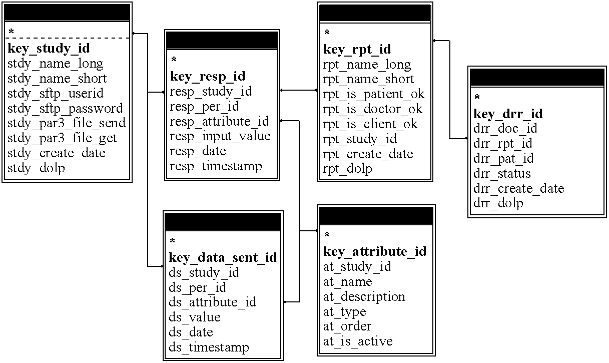

TABLE X
Bipolar Bidirectional Messaging Algorithm

| No.: Seq. Name | |
|---|---|
| 10: INTRO | Prompt: |
| MESSAGE | Hi, <first name>, this is your C.L.E.A.R program survey. If you have time |
| | to participate now, press 1, if not or you are not the right person, press 2. |
| | Actions: |
| | On 1: Go to 30: Enter ID |
| | On any other keypress: Go to 20: 3^{RD} PARTY INTRO PROMPT |
| | On No Entry: Go to 15: ANSWERING MACHINE MESSAGE |
| 15: ANSWERING | Message: |
| MACHINE | This is your C.L.E.A.R program survey for <FirstName><LastName>. |
| MESSAGE | Please contact us toll free at 1 866-818-9853 by <date> and enter PIN |
| | Number <PIN - will be static for each participant> when prompted. Thank |
| | you Goodbye. |
| | Action: |
| | Disconnect |
| 20: 3^{rd} PARTY | Prompt: |
| INTRO PROMPT | To tell us that you'll call us back later, press 1 |
| | If your mood prevents you from participating today, press 2 |
| | To have us call you back in an hour, press 3 |
| | If you'd like us to hold for <first name>, press 4 |
| | If you'd like to take a message, press 5 |
| | If you're ready now, press 6 |
| | To repeat these options, press star. |
| | Actions: |
| | On 1 go to 25: CALL BACK INSTRUCTIONS |
| | On 2 go to 25: CALL BACK INSTRUCTIONS (Note should we do a hope |
| | message instead?) |
| | On 3 go to 22: CALL LATER |
| | On 4 go to 930: HOLD ROUTINE |
| | On 5 go to 29: 3^{rd} PARTY MESSAGE |
| | On 6 go to 30: ENTER ID |
| | On Start go to 920: PRESS STAR |
| 22: CALL LATER | Prompt: |
| | Thank you, we will try you again in an hour.. |
| | Actions: |
| | End call |
| 25: CALL BACK | Message: |
| INSTRUCTIONS | Thank you, when you're ready, please contact us at 866-818-9853 and enter |
| | Patient access code <PIN.> when prompted. |
| | To repeat this information, press star |
| | If you need time to get a pen, press 1 |
| | To return to the previous menu, press #, |
| | Actions: |
| | On 1 Go to 930: HOLD ROUTINE |
| 29: 3^{rd} PARTY | Message: |
| MESSAGE | Please have <FirstName> contact us at 866-818-9853 and enter access code |
| | <PIN.> when prompted. |
| | To repeat this information, press star |
| | If you need time to get a pen, press 1 |
| | To return to the previous menu, press #, |
| | Thank you Goodbye. |
| | Actions: |
| | Actions: |
| | On 1 Go to 930: HOLD ROUTINE |
| 30: ENTER ID | Prompt: |
| | In order for us to protect your privacy please enter your patient ID now. |
| | To return to the previous menu, press #. |
| | Actions: |
| | On success/validation go to 40: WELCOME |
| | On fail/invalid go to 39: INVALID ID |
| 35: INBOUND | Prompt: |
| CALL BACK | Welcome to your C.L.E.A.R program message retrieval center. |
| | Please enter your Patient ID number followed by the pound sign. |
| | Actions: |
| | On success/validation go to 30: ENTERID |
| | On fail/invalid go to 39: INVALID ID |
| | Note: This will be used whether calling back from 15: ANSWERING |
| | MACHINE MESSAGE from Option 1 in 20 above. |
| 39: INVALID ID | Message: |
| | The number entered does not match our records. Please re-enter your patient |
| | ID number |
| | Actions: |
| | Go to 30: EnterID |
| 40: WELCOME | Message: |
| | “Welcome. Thanks for taking the time to participate. [skip begins here if |
| | press*] Tracking your mood every day can easily be completed together |
| | with taking your medications. It will help you and [doctor name] track how |
| | well your treatment works. In the future, you may press *[NP1] to skip this |
| | introduction.” |
| | Actions: |
| | On * at any time go to 50: SUICIDE SCREEN |
| | Go to 50: SUICIDE SCREEN |
| 50: SUICIDE | Message: |
| DISCLAIMER | “This is not a crisis hotline and is not a substitute for medical care. If you |
| | are thinking about suicide or harming yourself, please hang up and call your |
| | doctor immediately. You can reach [Dr. name] at [doctor phone number]. If |
| | you cannot reach your doctor, call 911 or go to the nearest emergency |
| | room.” |
| | Actions: |
| | Go to 60: GENERAL EDUCATION |
| 60: GENERAL | Logic: |
| EDUCATION | [different message each day of the month - repeat every 30 days] |
| | Message: |
| | [insert messages of hope (potential different voice than voice talent), |
| | factoids, and other general messages here - we will have enough to have a |
| | different one each day of the month - repeat every 30 days] |
| | Actions: |
| | Go to 100: MED NAME CHECK |
| MEDICINE | |
| 100: MED NAME | Logic: |
| CHECK (Logic) | If 100: MED NAME CHECK on hold due to discrepancy, |
| | go to 104: COMPLIANCE LOGIC; |
| | If 100: MED NAME CHECK hold released and we corrected error, |
| | go to 102: MED NAME CHECK UPDATE, |
| | If 100: MED NAME CHECK hold released and there was no error, |
| | go to 103: MED NAME CHECK UPDATE WRONG, |
| | Else go to 101. |
| 101: MED NAME | Message: “Now we are going to discuss how you have been taking your |
| CHECK PROMPT | medication.” |
| | Prompt: |
| | “According to our records, you are taking [data field: medication 1], [data |
| | field: medication 2], [data field: medication 3], [data field: medication 4], |
| | [data field: medication 5], and [data field: medication X]. Is this correct? |
| | Press 1 for yes or 2 for no.” |
| | Actions: |
| | On 1 go to 120: MED DOSE COUNT |
| | On 2 go to 105: MED NAME CHECK DISCREPANCY |
| | Any other entry go to 107: MED NAME CHECK PROMPT ERROR |
| 102: MED NAME | Prompt: |
| CHECK UPDATE | “We checked with [Dr. name]. We show you are taking [data field: |
| | medication 1], [data field: medication 2], [data field: medication 3], [data |
| | field: medication 4], [data field: medication 5], and [data field: medication |
| | X]. Is this correct? Press 1 for yes or 2 for no.” |
| | Actions: |
| | On 1 go to 120: MED DOSE COUNT |
| | On 2 go to 105: MED NAME CHECK DISCREPANCY |
| | Any other entry go to 108: MED NAME CHECK UPDATE ERROR |
| 103: MED NAME | Prompt: |
| CHECK UPDATE | “We checked with [Dr. name]. [Dr. name] said that you are taking [data |
| WRONG | field: medication 1], [data field: medication 2], [data field: medication 3], |
| | [data field: medication 4], [data field: medication 5], [data field: medication |
| | X]. You might know a medication by its brand name or its generic name. |
| | Please check the name on the bottle. Are all of these names correct? Press 1 |
| | for yes or 2 for no.” |
| | Actions: |
| | On 1 go to 120: MED DOSE COUNT |
| | On 2 go to 105: MED NAME CHECK DISCREPANCY |
| | Any other entry go to 109: MED NAME CHECK UPDATE WRONG |
| | ERROR |
| 104: MED NAME | Message: “We are checking with [Dr. name] about [data field: hold |
| CHECK PROMPT | medication 1], [data field: hold medication 2], . . . ” |
| HOLD VERSION | Prompt: “Are you still taking [list remaining medications]? Press 1 for yes |
| | or 2 for no.” |
| | Actions: |
| | On 1 go to 120: MED DOSE COUNT |
| | On 2 go to 105: MED NAME CHECK DISCREPANCY |
| | Any other entry go to ERROR |
| 105: MED NAME | Message: |
| CHECK | “Our records don't match something. Are you not taking one of these |
| DISCREPANCY | medications or are you taking something else that is not on this list? Press 1 |
| | if you're not taking one of these, or press 2 if you're taking something |
| | else. |
| | Actions: |
| | On 1 go to 106: MED NAME CHECK DISCREPANCY PROMPT |
| | On 2 go to 105.1: DISCREPANCY - TAKING SOMETHING ELSE |
| 105.1 | Prompt: |
| DISCREPANCY - | “We'll check with [Dr. name]. If you have any questions, you may contact |
| TAKING | your doctor. Are you still taking [data field: medication 1], [data field: |
| SOMETHING ELSE | medication 2], [data field: medication 3], [data field: medication 4], [data |
| | field: medication 5], [data field: medication X]? Press 1 for yes or 2 for no.” |
| | On 1 go to 120: MED DOSE COUNT |
| | On 2 go to 105: MED NAME CHECK DISCREPANCY |
| | Any other entry go to ERROR |
| 106: MED NAME | Prompt: |
| CHECK | “Which pills aren't you taking anymore? Press 1 if you aren't taking [data |
| DISCREPANCY | field: medication 1], press 2 if you aren't taking [data field: medication 2], |
| PROMPT | press 3 if you aren't taking [data field: medication 3], press 4 if you aren't |
| | taking [data field: medication 4], press 5 if you aren't taking [data field: |
| | medication 5], press X if you aren't taking [data field: medication X]. If you |
| | aren't taking more than one of these, select one, then we'll ask you again |
| | about the others.” |
| | Actions: |
| | On 1: place hold on 100: MED NAME CHECK for [data field: medication |
| | 1] until records are updated, and go to 106.1: MED DOSE COMPLIANCE |
| | PROMPT |
| | On 2: place hold on 100: MED NAME CHECK for [data field: medication |
| | 2] until records are updated, and go to 106.1: MED DOSE COMPLIANCE |
| | PROMPT |
| | On 3: place hold on 100: MED NAME CHECK for [data field: medication |
| | 3] until records are updated, and go to 106.1: MED DOSE COMPLIANCE |
| | PROMPT |
| | On 4: place hold on 100: MED NAME CHECK for [data field: medication |
| | 4] until records are updated, and go to 106.1: MED DOSE COMPLIANCE |
| | PROMPT |
| | On 5: place hold on 100: MED NAME CHECK for [data field: medication |
| | 5] until records are updated, and go to 106.1: MED DOSE COMPLIANCE |
| | PROMPT |
| | On X: place hold on 100: MED NAME CHECK for [data field: medication |
| | X] until records are updated, and go to 106.1: MED DOSE COMPLIANCE |
| | PROMPT |
| | On any other entry go to 106.1 MED NAME CHECK DISCREPANCY |
| | PROMPT ERROR |
| | Special: |
| | If any put on hold, fax doc saying, “On [data field: date], your patient, [data |
| | field: patient name], reported that they are no longer taking [data field: |
| | medication put on hold]. This information conflicts with what we have on |
| | file. Please fax back this form with an updated regimen or indicating that the |
| | medication has not changed. If you believe the patient is mistaken should be |
| | taking this [data field: medication put on hold], please contact them to |
| | resolve the issue.” |
| 106.1 MED NAME | Message: |
| CHECK | “There seemed to be a problem with your entry.” |
| DISCREPANCY | Actions: |
| PROMPT ERROR | Go to 106: MED NAME CHECK DISCREPANCY PROMPT |
| 106.2 MED NAME | Prompt: |
| CHECK PROMPT 2 | “We'll check with [Dr. name] about [data field: medication that was selected |
| | above]. If you have any questions, you may contact your doctor. Are you |
| | still taking [list remaining medications]? Press 1 for yes or 2 for no.” |
| | Actions: |
| | On 1 go to 120: MED DOSE COUNT |
| | On 2 go to 106.4: MED NAME CHECK DISCREPANCY 2 |
| | Any other entry go to 106.3 MED NAME CHECK DISCREPANCY |
| | PROMPT 2 ERROR |
| 106.3 MED NAME | Message: |
| CHECK | “There seemed to be a problem with your entry.” |
| DISCREPANCY | Actions: |
| PROMPT 2 ERROR | Go to 106.2: MED NAME CHECK DISCREPANCY PROMPT |
| 106.4 MED NAME | Need a loop here that deals with the possibility that someone is not taking |
| CHECK | more than one of their meds. It should loop them back through 106 to 106.2 |
| DISCREPANCY 2 | until we've captured all the meds from our list that they are NOT taking. |
| | The loop ends when they kick out to 120. |
| 107: MED NAME | Message: |
| CHECK PROMPT | “There seemed to be a problem with your entry.” |
| ERROR | Actions: |
| | Go to 101: MED NAME CHECK PROMPT |
| 108: MED NAME | Message: |
| CHECK UPDATE | “There seemed to be a problem with your entry.” |
| ERROR | Actions: |
| | Go to 102: MED NAME CHECK UPDATE |
| 109: MED NAME | Message: |
| CHECK UPDATE | “There seemed to be a problem with your entry.” |
| WRONG ERROR | Actions: |
| | Go to 103: MED NAME CHECK UPDATE WRONG |
| 120: MED DOSE | Note: At this point, the focus shifts to individual drugs. Thus, the logic |
| COUNT | below refers to each drug taken by the patient. |
| (logic) | Logic: |
| | If 120: MED DOSE COUNT on hold due to discrepancy, |
| | go to 180: COMPLIANCE LOGIC; |
| | If 120: MED DOSE COUNT hold released and we corrected error, |
| | go to 122: MED DOSE COUNT UPDATE, |
| | If 120: MED DOSE COUNT hold released and there was no error, |
| | go to 123: MED DOSE COUNT UPDATE WRONG, |
| | Else go to 121. |
| 121: MED DOSE | Prompt: |
| COUNT PROMPT | “How many [data field: medication 1] [data field: pill type (half or whole)] |
| Important | pills did you take yesterday? Please enter the number followed by the # |
| | sign. Enter zero # if you did not take any. Enter 99 if you have are now |
| | taking [data field: opposite pill type (whole or half)] pills of [data field: |
| | medication 1]?” |
| | Actions: |
| | On 99, go to 123.1: PILL TYPE DISCREPANCY |
| | Else, go to 124: MED DOSE COUNT CHECK |
| 122: MED DOSE | Message: |
| COUNT UPDATE | “We have corrected our records and now show that you are taking [data |
| | field: # of pills on file for medication 1] [data field: pill type (half or whole)] |
| | pills of [data field: medication 1].” |
| | Actions: |
| | Go to 121: MED DOSE COUNT PROMPT |
| 123: MED DOSE | Message: |
| COUNT UPDATE | “We checked with your doctor, who said you are taking [data field: # of pills |
| WRONG | on file for medication 1] [data field: pill type (half or whole)] pills of [data |
| | field: medication 1]. Please check the amount of your dose on the pill |
| | bottle.” |
| | Actions: |
| | Go to 121: MED DOSE COUNT PROMPT |
| 123.1 PILL TYPE | Prompt: |
| DISCREPANCY | Our records don't show that you are taking [data field: opposite pill type |
| | (whole or half)] pills of [data field: medication]. Did your physician change |
| | your dose? Press 1 for yes or 2 for no. |
| | Actions: |
| | On 1 go to 123.2: PILL TYPE DISCREPANCY VALID |
| | On 2 go to 123.3 PILL TYPE DISCREPANCY INVALID |
| | Any other entry go to 123.4 PILL TYPE DISCREPANCY ERROR |
| 123.2 PILL TYPE | Message: |
| DISCREPANCY | “We're going to check with your doctor about changes made to your |
| VALID | medications. If you have any questions, you may contact your doctor. We'll |
| | let you know when we've got things straight. Thanks.” |
| | Actions: |
| | Go to 180: MED SECTION LOOP |
| | Special: |
| | fax doc saying, “Your patient, [data field: patient name], reported taking |
| | [data field: opposite pill type (whole or half)] pills of [data field: medication] |
| | on [data field: date]. We had [data field: pill type (whole or half)] pills of |
| | [data field: medication] on record. Your patient indicated that you have |
| | changed the dose. Please fax back this form with an updated regimen or |
| | indicating that the dose has not changed. If you believe the patient is |
| | mistaken and should not be taking [data field: opposite pill type (whole or |
| | half)] pills of [data field: medication], please contact them to resolve the |
| | issue.” |
| 123.3 PILL TYPE | Message: |
| DISCREPANCY | “We're going to check with your doctor about changes made to your |
| INVALID | medications. If you have any questions, you may contact your doctor. We'll |
| | let you know when we've got things straight. Thanks.” |
| | Actions: |
| | Go to 180: MED SECTION LOOP |
| | Special: |
| | fax doc saying, “Your patient, [data field: patient name], reported taking |
| | [data field: opposite pill type (whole or half)] pills of [data field: medication] |
| | on [data field: date]. We had [data field: pill type (whole or half)] pills of |
| | [data field: medication] on record. Your patient indicated that you have not |
| | changed the dose. [data field: patient name] thinks they are taking the |
| | correct dose. Please contact the patient to resolve the issue.” |
| 123.4 PILL TYPE | Message: |
| DISCREPANCY | “There seemed to be a problem with your entry.” |
| ERROR | Actions: |
| | Go to 123.1 PILL TYPE DISCREPANCY |
| 124: MED DOSE | Logic: |
| COUNT CHECK | If 121: is 0 or [MED COUNT] NOT = [number of pills on file], |
| (logic) | go to 126: COMPLIANCE LOGIC; |
| | Else go to 125. |
| 125: MED DOSE | Message: |
| COUNT CORRECT | “It's terrific that you're taking all of your medication. Keep up the good |
| | work.” |
| | Actions: |
| | Go to 180: MED SECTION LOOP |
| 126: MED DOSE | Prompt: |
| COUNT CONFIRM | “Our records don't match the number of pills you are taking. Did your |
| | physician change your dose? Press 1 for yes or 2 for no.” |
| | Actions: |
| | On 1 go to 127: VALID MED DOSE CHANGE |
| | On 2 go to 128: INVALID MED DOSE CHANGE |
| | Any other entry go to 129: MED DOSE COUNT CONFIRM ERROR |
| 127: VALID MED | Message: |
| DOSE CHANGE | “We're going to check with your doctor about changes made to your |
| | medications. If you have any questions, you may contact your doctor. We'll |
| | let you know when we've got things straight. Thanks.” |
| | Actions: |
| | Go to 180: MED SECTION LOOP |
| | Special: |
| | fax doc saying, “Your patient, [data field: patient name], reported taking |
| | [data field: med count] [data field: medication 1] pills on [data field: date]. |
| | This dose conflicts with the dose we have on file, however the patient |
| | indicates that you have changed the dose. Please fax back this form with |
| | an updated regimen or indicating that the dose has not changed. If you |
| | believe the patient is mistaken and should not be taking this quantity of pills, |
| | please contact them to resolve the issue.” |
| 128: INVALID MED | Logic: |
| DOSE CHANGE | If 121: is 0 or [MED COUNT] less than [number of pills on file], |
| (logic) | go to 140: MED UNDERDOSE |
| | Else go to 160: MED OVERDOSE. |
| | Special: |
| | fax doc saying, “Your patient, [data field: patient name], reported taking |
| | [data field: med count] [data field: medication 1] pills on [data field: date]. |
| | This dose conflicts with the dose we have on file, and the patient indicates |
| | that you have not changed the dose. [data field: patient name] thinks they |
| | are taking the correct dose. Please contact the patient to resolve the issue.” |
| 129: MED DOSE | Message: |
| COUNT CONFIRM | “There seemed to be a problem with your entry.” |
| ERROR | Actions: |
| | Go to 126: MED DOSE COUNT CONFIRM |
| 140: MED NUMBER | Logic: |
| CHECK | If this is the primary medication ([MED NUMBER] = 1), |
| (logic) | go to 141: MED UNDERDOSE |
| | Else go to 150: ALT MED UNDERDOSE. |
| 141: MED | Prompt: |
| UNDERDOSE | “It looks like you took fewer pills than the doctor prescribed.. Press 1 if you |
| | ran out of medication. Press 2 if you forgot. Press 3 if you think you took |
| | the correct number of pills. Press 4 if you're trying to reduce your side |
| | effects. Press 5 if you're feeling better and don't think you need to take it. |
| | Press 6 if you made a mistake when you entered the number of pills you |
| | took.” |
| | Actions: |
| | On 1 go to 142: MED RAN OUT |
| | On 2 go to 143: MED FORGOT |
| | On 3 go to 144: MED THINK CORRECT |
| | On 4 go to 145: MED REDUCE SIDE EFFECTS |
| | On 5 go to 146: USED TO FEEL |
| | On 6 go to 120: MED DOSE COUNT |
| | Any other entry go to 149: MED UNDERDOSE ERROR |
| 142: MED RAN OUT | Message: |
| | “Always order a refill about 5 days before you run out because it can take a |
| | couple of days to get a refill. If you have trouble remembering, many |
| | pharmacies now offer a reminder service or you can ask a friend or family |
| | member to help you.” |
| | Custom Messages: (based on med type, can push extra cautions here) |
| | Actions: |
| | Go to 148: MED ZERO CHECK |
| 143: MED FORGOT | Message: |
| | “Here's a tip for remembering to take your medication - make it part of your |
| | daily routine. For example, put your pills right next to your toothpaste so |
| | you remember to take them when you brush your teeth in the morning or at |
| | night.” |
| | Custom Messages: (based on med type, can push extra cautions here) |
| | Actions: |
| | Go to 148: MED ZERO CHECK |
| 144: MED THINK | Message: |
| CORRECT | “The number of pills you reported taking doesn't match the information we |
| | have on file. You may not be taking the correct number. We'll check with |
| | your doctor and get back to you.” |
| | Custom Messages: (based on med type, can push extra cautions here) |
| | Actions: |
| | Go to 148: MED ZERO CHECK |
| 145: MED REDUCE | Message: |
| SIDE EFFECTS | “Side effects can be hard to deal with. However, it's important not to take |
| | less of your medication or stop taking it completely without first talking to |
| | your doctor. Call your doctor as soon as you can to talk about this.” |
| | Custom Messages: (based on med type, can push extra cautions here) |
| | Actions: |
| | If LITHIUM is true, go to 147: MED LITHIUM EXTRA |
| | Else, go to 148: MED ZERO CHECK |
| 146: USED TO FEEL | Message: |
| | “Never stop taking your medication because you feel better unless you talk |
| | to your doctor first. If you stop without your doctor's permission there's a |
| | real good chance you will begin feeling bad again.” |
| | Custom Messages: (based on med type, can push extra cautions here) |
| | Actions: |
| | If LITHIUM is true, go to 147: MED LITHIUM EXTRA |
| | Else, go to 148: MED ZERO CHECK |
| 147: MED LITHIUM | Message: |
| EXTRA | “As we said before, if you're taking Lithium, it's important to not stop |
| | without your doctor's permission because your risk of suicide might |
| | increase. If you feel you have to stop taking your Lithium, never do so on |
| | your own. Call your doctor right away.” |
| | Actions: |
| | Go to 148: MED ZERO CHECK |
| 148: MED ZERO | Logic: |
| CHECK | If MED COUNT = 0, set the MEDZERO flag. |
| (logic) | Go to 180: MED SECTION LOOP |
| Important | Special: |
| | If user has multiple recent count of zero meds, {≧2 days in a row or ≧2 |
| | days out of past 7 days}: |
| | send PRIORITY REPORT to doc (“Your patient, [data field: patient name], |
| | has not taken their [data field: medication] for two out of the past 7 days. |
| | This message is dated [data field: date].”) |
| 149: MED | Message: |
| UNDERDOSE | “There seemed to be a problem with your entry.” |
| ERROR | Actions: |
| | Go to 141: MED UNDERDOSE |
| 150: ALT MED | Prompt: |
| UNDERDOSE | “It looks like you took fewer pills than the doctor prescribed.. Press 1 if you |
| PROMPT | ran out of medication. Press 2 if you forgot. Press 3 if you think you took |
| | the correct number of pills. Press 4 if you're trying to reduce your side |
| | effects. Press 5 if you're feeling better and don't think you need to take it. |
| | Press 6 if you made a mistake when you entered the number of pills you |
| | took.” |
| | Actions: |
| | On 1 go to 151: ALT MED UNDERDOSE MESSAGE |
| | On 2 go to 151: ALT MED UNDERDOSE MESSAGE |
| | On 3 go to 151: ALT MED UNDERDOSE MESSAGE |
| | On 4 go to 151: ALT MED UNDERDOSE MESSAGE |
| | On 5 go to 151: ALT MED UNDERDOSE MESSAGE |
| | On 6 go to 120: MED DOSE COUNT |
| | Any other entry go to 159: ALT MED UNDERDOSE PROMPT ERROR |
| 151: ALT MED | Message: |
| UNDERDOSE | “It looks like you've missed taking your medication as prescribed more than |
| MESSAGE | once. It's important you always take it. If this is too difficult for you, you |
| | should call your doctor right away.” |
| | Actions: |
| | Go to 148: MED ZERO CHECK |
| 159: ALT MED | Message: |
| UNDERDOSE | “There seemed to be a problem with your entry.” |
| PROMPT ERROR | Actions: |
| | Go to 150: ALT MED UNDERDOSE PROMPT |
| 160: MED | Prompt: |
| OVERDOSE | “From what you report, you may be taking more medication than your |
| Important | doctor prescribed. This can cause some serious side effects. Never change |
| | how you take your medication without first talking with your doctor. If |
| | you're not sure if you've taken too much medication, call your doctor right |
| | away. If you can't get in touch with [Dr. name], call 911 or go to the nearest |
| | emergency room right away.” |
| | Press 1 to hear these instructions again, press 2 to end this call so you can |
| | contact someone, press 3 if you believe you have taken the correct number |
| | of pills and have received this message in error, press 4 if you incorrectly |
| | entered the number of pills you took”, press 5 to continue.” |
| | Custom Messages: (based on med type, can push extra cautions here) |
| | Actions: |
| | On 1 go to 160: MED OVERDOSE |
| | On 2 (or hang up) END CALL |
| | On 3 go to 180: MED SECTION LOOP |
| | On 4 go to 120: MED DOSE COUNT |
| | On 5 go to 180: MED SECTION LOOP |
| | Any other entry go to 169: MED OVERDOSE ERROR |
| 169: MED | Message: |
| OVERDOSE ERROR | “There seemed to be a problem with your entry.” |
| | Actions: |
| | Go to 160: MED OVERDOSE |
| 180: MED SECTION | Logic: |
| LOOP | Increment med number. |
| (logic) | If med number is greater than total meds for this patient, |
| | go to 200: MOOD REVIEW |
| | Else, go to 120: MED DOSE COUNT |
| MOOD | |
| 200: MOOD | Logic: |
| REVIEW | If first contact with this patient, |
| (logic) | go to 210: SPLIT MOOD CHECK |
| Important | Else, go to 201: MOOD REVIEW MESSAGE |
| 201: MOOD REVIEW | Message: |
| INTRO | “Now we are going to review your mood rating from last time.” |
| Important | Actions: |
| | Go to 202: MOOD REVIEW LOGIC |
| 202: MOOD | Logic: |
| REVIEW LOGIC | If no mood scale for past 7 days: |
| Important | go to 205: MOOD REVIEW OPTION 3 |
| | Else if no mood scale was received yesterday (note this could only occur if |
| | patient hung up midway or did not answer): |
| | go to 203: MOOD REVIEW OPTION 1 |
| | Else if last mood rating was a split mood: |
| | go to 204: MOOD REVIEW OPTION 2 |
| | Else (default): |
| | go to 206: MOOD REVIEW OPTION 4 |
| 203: MOOD | Message: |
| REVIEW OPTION 1 | “When we called last time, you didn't rate your mood. It's important you do |
| Important | this every day. This information is really useful for [Dr. name] to see how |
| | well your treatment is working.” |
| | Actions: |
| | Go to 210: SPLIT MOOD CHECK |
| 204: MOOD | Message: |
| REVIEW OPTION 2 | “Last time you rated your mood as split, with your highest rating a [Data |
| Important | Entry from 111: MOOD CYCLE ONE from most recent rating] and your |
| | lowest a [Data Entry from 112: MOOD CYCLE TWO from most recent |
| | rating]” |
| | Actions: |
| | Go to 210: SPLIT MOOD CHECK |
| 205: MOOD | Message: |
| REVIEW OPTION 3 | “You have not made a mood rating for the past 7 days. It's important you do |
| Important | this every day. This information is really useful for [Dr. name] to see how |
| | well your treatment is working.” |
| | Actions: |
| | Go to 210: SPLIT MOOD CHECK |
| 206: MOOD | Message: |
| REVIEW OPTION 4 | “Last time, you rated your mood a [data field: mood rating from most recent |
| Important | rating].” |
| | Actions: |
| | Go to 210: SPLIT MOOD CHECK |
| 210: SPLIT MOOD | Prompt: |
| CHECK | “When thinking about your mood yesterday, did you experience switching |
| | mood states? Press 1 for yes, 2 for no, or 9 to hear examples of switching |
| | mood states.” |
| | Actions: |
| | On 1 go to 230: MOOD CYCLE CHECK |
| | On 2 go to 220: MOOD INPUT INTRODUCTION |
| | On 9 go to 215: MOOD CYCLE EXAMPLES |
| | Any other entry, go to 219: SPLIT MOOD CHECK ERROR |
| 215: MOOD CYCLE | Message: |
| EXAMPLES | “Examples of switching within a day include: sudden, distinct, and large |
| | mood changes between depression and mania within a single day.” |
| | Actions: |
| | Go to 210: SPLIT MOOD CHECK |
| 219: SPLIT MOOD | Message: |
| CHECK ERROR | “There seemed to be a problem with your entry.” |
| Essential | Actions: |
| | Go to 210: SPLIT MOOD CHECK |
| 220: MOOD INPUT | Message: |
| INTRODUCTION | “Now we are going to ask you to rate how you felt yesterday.” |
| Essential | Actions: |
| | Go to 221: MOOD INPUT MESSAGE |
| 221: MOOD INPUT | Message: |
| MESSAGE | “On a scale of 0 to 100, where 0 is the most depressed you could imagine |
| Essential | being, 50 is a balanced or level mood, and 100 is the most energetic, |
| | activated, or manic you could ever be, how would you rate your mood |
| | yesterday?” |
| | Actions: |
| | Go to 222: MOOD INPUT MESSAGE |
| 222: MOOD INPUT | Prompt: |
| PROMPT | “Please enter a number between 0 and 100, followed by the # key. If you |
| Essential | would like to hear some example ratings on the 0 to 100 scale, press 999 |
| | followed by the # key.” |
| | Actions: |
| | On 51 to 100 go to 300: DYSPHORIC CHECK |
| | On 0-50 go to 400: CUSTOM EDUCATION LOGIC |
| | On 999 go to 225: MOOD INPUT EXAMPLES |
| | Any other entry, go to 229: MOOD INPUT ERROR |
| 225: MOOD INPUT | Message: |
| EXAMPLES | “Example ratings. If yesterday you felt moderately depressed, you might |
| Essential | rate your mood as 32 or 35, or if you felt a little manic, you might rate your |
| | mood as 54 or 57.” |
| | Actions: |
| | Go to 222: MOOD INPUT MESSAGE |
| 229: MOOD INPUT | Message: |
| ERROR | “There seemed to be a problem with your entry.” |
| Essential | Actions: |
| | Go to 222: MOOD INPUT MESSAGE |
| 230: MOOD CYCLE | Message: |
| CHECK MESSAGE | “Please note that feeling worse in the morning and a very gradual |
| Essential | improvement during the day (or better in the morning with a gradual |
| | worsening as the day goes on) should not be counted as a mood switch.” |
| | Actions: |
| | Go to 231: MOOD CYCLE CHECK PROMPT |
| 231: MOOD CYCLE | Prompt: |
| CHECK PROMPT | “Press 1 to continue and rate two mood levels, or press 2 to return to rate a |
| Essential | single mood.” |
| | Actions: |
| | On 1 go to 240: MOOD CYCLE ONE |
| | On 2 go to 221: MOOD INPUT MESSAGE |
| | On any other entry: go to 239: MOOD CYCLE CHECK ERROR |
| 239: MOOD CYCLE | Message: |
| CHECK ERROR | “There seemed to be a problem with your entry.” |
| | Actions: |
| | Go to 231: MOOD CYCLE CHECK PROMPT |
| 240: MOOD CYCLE | Prompt: |
| ONE | “Please enter the highest or most energized mood you experienced |
| Essential | yesterday. Please enter a number between 0 and 100, followed by #. If you |
| | would like to hear some example ratings on the 0 to 100 scale, press 999 |
| | followed by the # key.” |
| | Actions: |
| | On 0 to 100 go to 250: MOOD CYCLE TWO |
| | On 999 go to 225: MOOD INPUT EXAMPLES |
| | Any other entry, go to 249: MOOD CYCLE ONE ERROR |
| 249: MOOD CYCLE | Message: |
| ONE ERROR | “There seemed to be a problem with your entry.” |
| Essential | Actions: |
| | Go to 240: MOOD CYCLE ONE |
| 250: MOOD CYCLE | Prompt: |
| TWO | “Please enter the lowest mood you experienced yesterday. Please enter a |
| Essential | number between 0 and 100, followed by #. If you would like to hear some |
| | example ratings on the 0 to 100 scale, press 999 followed by the # key.” |
| | Actions: |
| | On 0 to 100 go to 260: MOOD CYCLE COUNT |
| | On 999 go to 225: MOOD INPUT EXAMPLES |
| | $$ Any other entry, go to 259: MOOD CYCLE TWO ERROR |
| 259: MOOD CYCLE | Message: |
| TWO ERROR | “There seemed to be a problem with your entry.” |
| Essential | Actions: |
| | Go to 250: MOOD CYCLE TWO |
| 260: MOOD CYCLE | Prompt: |
| COUNT | “Please enter the number of times you switched between a higher and a |
| Essential | lower state yesterday, followed by #. One switch would mean that you |
| | experienced two mood states.” |
| | Actions: |
| | On 0# to 100# |
| | go to 300: DYSPHORIC CHECK |
| | On any other input go to 269: MOOD CYCLE COUNT ERROR |
| | Special: |
| | On 0# to 100# |
| | set SPLIT_FLAG to TRUE |
| 269: MOOD CYCLE | Message: |
| COUNT ERROR | “There seemed to be a problem with your entry.” |
| Essential | Actions: |
| | Go to 260: MOOD CYCLE COUNT |
| SEVERITY | |
| 300: DYSPHORIC | Prompt: |
| CHECK | “When you felt energized or manic, did you experience unhappiness, |
| Important | irritability, or anxious uneasiness? Press 1 for Yes or 2 for No” |
| | Actions: |
| | On 1 go to 400: CUSTOM EDUCATION LOGIC |
| | On 2 go to 400: CUSTOM EDUCATION LOGIC |
| | Any other entry: go to 309 |
| | Special: |
| | Set the Dysphoric Flag. |
| 309: DYSPHORIC | Message: |
| CHECK ERROR | “There seemed to be a problem with your entry.” |
| | Actions: |
| | Go to 300: DYSPHORIC CHECK |
| EDUCATION | |
| 400: CUSTOM | Logic: |
| EDUCATION | If 222 < 40 go to 410: GENERAL DEPRESSION EDUCATION |
| LOGIC | If 222 > 60 go to 420: GENERAL MANIA EDUCATION |
| | If 222 > 60 and 300 (DYSPHORIC CHECK) = 1 go to 430: DYSPHORIC |
| | MANIA EDUCATION |
| | If 231 (MOOD CYCLE CHECK PROMPT) = 1 and 300 (DYSPHORIC |
| | CHECK) = 2 go to 440: SPLIT MOOD NO DYSPHORIA EDUCATION |
| | If 231 (MOOD CYCLE CHECK PROMPT) = 1 and 300 (DYSPHORIC |
| | CHECK) = 1 go to 450: SPLIT MOOD WITH DYSPHORIA EDUCATION |
| 410: GENERAL | Add education |
| DEPRESSION | Go to 500: SLEEP REVIEW |
| EDUCATION | |
| 420: GENERAL | Add education |
| MANIA | Go to 500: SLEEP REVIEW |
| EDUCATION | |
| 430: DYSPHORIC | Add education |
| MANIA | Go to 500: SLEEP REVIEW |
| EDUCATION | |
| 440: SPLIT MOOD | Add education |
| NO DYSPHORIA | Go to 500: SLEEP REVIEW |
| EDUCATION | |
| 450: SPLIT MOOD | Add education |
| WITH DYSPHORIA | Go to 500: SLEEP REVIEW |
| EDUCATION | |
| SLEEP | |
| 500: SLEEP | Logic: |
| REVIEW | If first contact with the patient, |
| (logic) | go to 505: SLEEP REVIEW INPUT |
| Marginal | Else if patient did not respond yesterday, |
| | go to 502: SLEEP REVIEW NO YESTERDAY |
| | Else, |
| | go to 501: SLEEP REVIEW MESSAGE |
| 501: SLEEP | Message: |
| REVIEW MESSAGE | “Yesterday, you said that you slept [data field: sleep rating from previous |
| Marginal | day] hours.” |
| | Actions: |
| | Go to 505: SLEEP REVIEW INPUT |
| 502: SLEEP | Message: |
| REVIEW NO | “Yesterday, you did not make a sleep rating. It's important you do this |
| YESTERDAY | every day.” |
| Marginal | Actions: |
| | Go to 505: SLEEP REVIEW INPUT |
| 505: SLEEP INPUT | Prompt: |
| Important/Marginal | “Please enter the number of hours of sleep you slept last night. If you slept |
| | part of an hour, round up. For example, 4 hours and 15 minutes or 4-and-a- |
| | half hours counts as 5. Please count only your main sleep time and do not |
| | include naps you might have taken several hours after you got up. Please |
| | enter a number of hours of sleep now, followed by the # sign.” |
| | Actions: |
| | On 0 to 24 go to 700: CONCLUSION |
| | Any other entry, go to 509: SLEEP REVIEW INPUT ERROR |
| 509: SLEEP | Message: |
| REVIEW INPUT | “There seemed to be a problem with your entry.” |
| ERROR | Actions: |
| Important/Marginal | Go to 505: SLEEP REVIEW INPUT |
| SUPPLEMENTARY | |
| QUESTIONS | |
| 600: | Logic: |
| SUPPLEMENTARY | These questions will be pushed to patients once every 7 days, beginning on |
| QUESTION LOGIC | the 7^{th} day after their first contact. |
| | Actions: |
| | Go to 610: MAJOR LIFE EVENT |
| 610: MAJOR LIFE | Message: “We'd now like to ask you a few extra questions about things that |
| EVENT | happened last week. We'll only ask you these questions once a week.” |
| | Prompt: |
| | “Did you have a major life event last week such as starting a new job, |
| | moving, an argument with a friend or loved one, or anything else that really |
| | affected you? Press 1 for yes or 2 for no. |
| | Action: |
| | On 1 go to 620: MENSTRUATION LOGIC |
| | On 2 go to 620: MENSTRUATION LOGIC |
| 620: | Logic: |
| MENSTRUATION | If [gender from enrollment form] = female, go to 630: MENSTRUATION |
| LOGIC | Else go to 640: ALCOHOL AND DRUGS |
| 630: | Prompt: |
| MENSTRUATION | “Did you have your period last week? Press 1 for yes or 2 for no.” |
| | Action: |
| | On 1 go to 640: ALCOHOL AND DRUGS |
| | On 2 go to 640: ALCOHOL AND DRUGS |
| 640: ALCOHOL | Prompt: |
| AND DRUGS | “Did you binge on alcohol or takes drugs last week? Press 1 for yes or 2 for |
| | no.” |
| | Action: |
| | On 1 go to 700: CONCLUSION |
| | On 2 go to 700: CONCLUSION |
| CONCLUSION | |
| 700: CONCLUSION | Message: |
| Essential | “Thank you for tracking your medications and completing your mood chart. |
| | This makes it easier for you and [doctor name] to track how your treatment |
| | is going.” |
| | Actions: |
| | END CALL |
| STANDARD | |
| OPTIONS | |
| 900: NO ENTRY | Message: |
| | “I'm sorry, I did not get a response” |
| | Action: |
| | Replay message and prompt |
| 910: INVALID | Message: |
| ENTRY | “I'm sorry, that was not a valid response” |
| | Action: |
| | Replay message and prompt |
| 920: PRESS STAR | Action: |
| | Repeat message and menu |
| 930: HOLD | Message: |
| ROUTINE | “<Music> This is the CLEAR Program study holding for <First Name>. |
| | Press any key to continue. (repeat for 1 minute)” |
| | Action: |
| | ANY KEPYPRESS or TIMOUT: Replay message and Prompt |

What is claimed is:

1. A method for extending provider-patient communication beyond an office setting, comprising:
providing an events-driven patient database;
creating an application patient database from the events-driven patient database;
accessing the application patient database via a feedback oriented bi-directional messaging system to highlight a target patient;
communicating with the target patient via a communication medium using the bi-directional messaging system;
receiving feedback data from the target patient via the communication medium and conveying the feedback data to the application patient database; and
updating the application patient database using the feedback data received from the target patient.

2. The method of claim 1, wherein the events-driven patient database includes data from bipolar, depression, diabetes and asthma patients modules.

3. The method of claim 1, wherein the application patient database includes customized/personalized asthma patient data.

4. The method of claim 3, wherein said asthma patient data includes disclaimer information, previous reinforcement information, education information, reinforcement information, and reminders information.

5. The method of claim 1, wherein the bi-directional messaging system includes a PAR3 messaging system module.

6. The method of claim 1, wherein the bi-directional messaging system includes a patient specific algorithm tailored to the application database that controls information flowing on the communication medium to the target patient.

7. The method of claim 6, wherein the patient specific algorithm includes content related to asthma patients, further comprising:
contacting the target patient at least three times weekly, of five minutes duration, respectively;
providing an educational information module regarding asthma;
accessing an asthma condition status module;
providing a behavioral reminders module related to a treatment plan adherence module;
accessing the target patient name, gender, age, asthma drugs and self-reported information via an introduction/authentication module; and
conducting a monthly survey for six months of at least twenty minutes, but no more than thirty minutes duration to assess results of the patient specific algorithm.

8. The method of claim 6, wherein the patient specific algorithm includes content related to bipolar patients, further comprising;
contacting the target patient at least three times weekly of five minutes duration, respectively;
providing an educational information module regarding bipolar disorders;
aggregating a patient mood chart data module;
alerting a specific patient behaviors module;
accessing the target patient name, caregiver name and medication name via an introduction/authentication module;
accessing suicide screen, medication adherence, mood rating, mood severity and sleep rating modules to assay the bipolar disorder; and
summarizing content related to the bipolar patients via a conclusion module and conducting a monthly survey for six months to assess results of the bipolar patient specific algorithm.

9. The method of claim 6, wherein the patient specific algorithm includes content related to diabetes patients, further comprising:
contacting the target patient at least three times weekly of five minutes duration, respectively;
authenticating the target patient and accessing the target patient name, caregiver name and medication name via an introduction/authentication module;
accessing a previous reinforcement module for the feedback data;
accessing an education module for educating the target patient on diabetes data specific to the target patient;
accessing a reinforcement module to reinforce patient diabetes management and home blood glucose tests;
accessing a reminders module to remind the target patient to adhere to diabetes medication and regimentation; and
summarizing content related to the diabetes patient via a conclusion module and conducting a monthly survey for six months to assess results of the diabetes patient specific algorithm.

10. The method of claim 6, wherein the patient specific algorithm includes content related to patients experiencing depression, further comprising;
contacting the target patient at least three times weekly of five minutes duration, respectively;
authenticating the target patient and accessing the target patient's history and medication via an introduction/authentication module;
accessing a previous reinforcement module for the feedback data;
accessing an education module for educating the target patient on depression and crisis management specific to the target patient;
accessing a reinforcement module to reinforce crisis management and medication adherence;
accessing a reminders module to remind the target patient to adhere to their as prescribed medications; and
summarizing content related to the target patient experiencing depression via a conclusion module and conducting a monthly survey for six months to assess results of the patient specific algorithm.

11. The method of claim 1, wherein the communication medium includes a land-line telephone.

12. The method of claim 1, wherein the communication medium includes a fax machine.

13. The method of claim 1, wherein the communication medium includes a cellular telephone.

14. The method of claim 1, wherein the communication medium includes a personal computer accessing a conventional web server.

15. The method of claim 1, wherein the communication medium includes a personal data assistant.

16. The method of claim 1, further comprising communicating with the target patient via the communication medium that includes a combination of a land-line telephone, a fax machine, a cellular telephone, a personal computer and a personal data assistant.

17. A method for extending provider-patient communication beyond an office setting, comprising:
providing an events-driven patient database;
creating an application patient database from the events-driven patient database;
accessing the application patient database via a PAR3 messaging system to highlight a target patient;
communicating with the target patient using a land-line telephone;
receiving feedback data from the target patient via the land-line telephone and conveying the feedback data to the application database via a conventional web-based computer; and updating the application patient database using the feedback data.
